(19) United States
(12) Patent Application Publication
(10) Pub. No.: US 2024/0402301 A1
(43) Pub. Date: Dec. 5, 2024

(54) MANAGING AN OPTICAL PROBE BEAM FOR DISPLACEMENT SENSING

(71) Applicant: Arizona Board of Regents on Behalf of the University of Arizona, Tucson, AZ (US)

(72) Inventors: Wenhua He, Tucson, AZ (US); Salkat Guha, Tucson, AZ (US)

(73) Assignee: Arizona Board of Regents on Behalf of the University of Arizona, Tucson, AZ (US)

(21) Appl. No.: 18/693,196

(22) PCT Filed: Sep. 22, 2022
(86) PCT No.: PCT/US2022/044324

§ 371 Date: Mar. 19, 2024

Related U.S. Application Data
(60) Provisional application No. 63/247,931, filed on Sep. 24, 2021.

(51) Int. Cl. G01S 7/48; G01S 7/481; H04B 10/112; H04B 10/70

(52) U.S. Cl. CPC G01S 7/4802; G01S 7/4812; H04B 10/1121; H04B 10/70

(57) ABSTRACT

An optical beam is provided from a transmitter aperture to a receiver aperture that receives the optical beam after displacement by a path shifting component. Received initial displacement information characterizing at least one of: an initial estimate of the displacement, or an indication that the displacement is below a predetermined threshold. Received input beams each have a different spatial mode, from a set of mutually orthogonal spatial modes that include: a lowest order spatial mode, a highest order spatial mode, and one or more intermediate order spatial modes. A relative amount of each of the input beams to be included in the optical beam is determined based at least in part on: corresponding diffraction loss estimates for each of the input beams, and the initial displacement information. One of the input beams that has a largest relative amount in the optical beam is one of the intermediate order spatial modes.

### CROSS-REFERENCE TO RELATED APPLICATION(S)

This application claims priority to and the benefit of U.S. Provisional Application Patent Ser. No. 63/247,931, entitled “MANAGING AN OPTICAL PROBE BEAM FOR DISPLACEMENT SENSING,” filed Sep. 24, 2021, the entire disclosure of which is hereby incorporated by reference.

### STATEMENT AS TO FEDERALLY SPONSORED RESEARCH

This invention was made with government support under Grant No. N00014-19-1-2189 awarded by NAVY/ONR. The government has certain rights in the invention.

### TECHNICAL FIELD

This disclosure relates to managing an optical probe beam for displacement sensing.

### BACKGROUND

A variety of sensing systems use an optical beam as a probe and include a path shifting component that causes a small transverse displacement of the optical beam in response to a characteristic to be sensed (e.g., measured, observed, recorded, or tracked). The sensing system can be configured to estimate that small transverse displacement as part of a measurement performed by the sensing system. For example, the sensing system may be a system for performing atomic-force microscopy, or other ultra precise measurement based on optical lever, single-molecule tracking, pointing-acquisition-tracking for free-space optical communications, or active alignment of an optical system (e.g., super resolution imaging).

### SUMMARY

In one aspect, in general, a method for providing an optical beam from a transmitter aperture to a receiver aperture that receives the optical beam after displacement of the optical beam within the receiver aperture caused by a path shifting component includes: receiving initial displacement information characterizing at least one of: an initial estimate of the displacement, or an indication that the displacement is below a predetermined threshold. The method includes: receiving a plurality of input beams each having a different spatial mode, from a set of mutually orthogonal spatial modes, where the set of mutually orthogonal spatial modes include: a lowest order spatial mode, a highest order spatial mode, and one or more intermediate order spatial modes each having a mode order between the lowest order spatial mode and the highest order spatial mode. The method includes determining a relative amount of each of the input beams to be included in the optical beam based at least in part on: corresponding diffraction loss estimates for each of the input beams, and the initial displacement information. One of the input beams that has a largest relative amount in the optical beam is one of the intermediate order spatial modes.

In another aspect, in general, an apparatus includes: a transmitter configured to provide an optical beam from a transmitter aperture, the optical beam comprising a plurality input beams each having a different spatial mode, from a set of mutually orthogonal spatial modes, where the set of mutually orthogonal spatial modes include: a lowest order spatial mode, a highest order spatial mode, and one or more intermediate order spatial modes each having a mode order between the lowest order spatial mode and the highest order spatial mode; and a receiver configured to receive the optical beam at a receiver aperture after displacement of the optical beam within the receiver aperture caused by a path shifting component, and to provide initial displacement information characterizing at least one of: an initial estimate of the displacement, or an indication that the displacement is below a predetermined threshold. The transmitter is further configured to determine a relative amount of each of the input beams to be included in the optical beam based at least in part on: corresponding diffraction loss estimates for each of the input beams, and the initial displacement information. One of the input beams that has a largest relative amount in the optical beam is one of the intermediate order spatial modes.

Aspects can include one or more of the following features.

Each diffraction loss estimate is different and is determined based at least in part on estimates of: an area of the transmitter aperture, an area of the receiver aperture, a propagation distance between the transmitter aperture and the receiver aperture, and a wavelength of the optical beam.

A Fresnel number product based on the estimates of the area of the transmitter aperture, the area of the receiver aperture and the propagation distance is greater than 10.

An initial measurement is performed to determine the initial estimate of the displacement.

Determining a relative amount of each of the input beams to be included in the optical beam includes performing an optical transformation on one or more of the input beams to produce at least one non-classical squeezed state of at least a portion of the optical beam.

The non-classical squeezed state is a Gaussian state.

Determining a relative amount of each of the input beams to be included in the optical beam includes performing an optical transformation on one or more of the input beams to produce the optical beam in which all spatial modes of the optical beam are in a classical non-squeezed state.

The classical non-squeezed state is a Gaussian state.

The plurality of input beams are generated from at least one coherent optical beam passed through a spatial mode sorter.

The optical beam is detected after the optical beam is received by the receiver aperture, and a measurement of the displacement is determined based at least in part on one or more detected values.

The one or more detected values comprise a plurality of detected values from an arrangement of pixels in an image plane.

The detected values comprise detected photon numbers associated with different spatial modes of the received optical beam.

The set of mutually orthogonal spatial modes are a finite number of Hermite-Gaussian spatial modes.

Aspects can have one or more of the following advantages.

Techniques described herein include example implementations for a classical transmitter and corresponding receiver (or for a module capable of performing some or all of the functionality of both a transmitter and receiver, called a transceiver), and example implementations for a quantum-enhanced transmitter. In some cases, the examples can be configured to achieve an optimal result under appropriate operating conditions. In some cases, the techniques described herein can be used to achieve a result that is not necessarily optimal, but may be an improvement over other possible techniques. An example multimodal design explores the potential of a free space setup for the task of sensing a small transverse displacement. In some implementations, with a prior estimate of a small transverse displacement as input, the techniques are able to provide a measurement with improved precision.

Other features and advantages will become apparent from the following description, and from the figures and claims.

### BRIEF DESCRIPTION OF THE DRAWINGS

The disclosure is best understood from the following detailed description when read in conjunction with the accompanying drawing. It is emphasized that, according to common practice, the various features of the drawing are not to-scale. On the contrary, the dimensions of the various features are arbitrarily expanded or reduced for clarity.

FIG. 1 is a schematic diagram of an example sensing system.

FIG. 2 is a schematic diagram of an example transverse displacement.

FIG. 3A is a plot of the quantum Fisher information as a function of the number of Hermite Gauss spatial modes used to create transmitted coherent states, for various Fresnel number products and for a fixed total mean photon number of the transmitted coherent states.

FIG. 3B is a plot of the quantum Fisher information as a function of the Fresnel number product, for various states at the transmitter.

FIG. 4A is an example of an optimal classical transmitter state.

FIG. 4B is an example of the spatial mode of a receiver state that will saturate the quantum Fisher information for an optimal classical transmitter state.

FIG. 5A is a schematic diagram of an example sensing system.

FIG. 5B, FIG. 5C, FIG. 5D, FIG. 5E, and FIG. 5F are schematic diagrams of example mode sorters.

FIG. 6 is a flowchart of an example displacement sensing procedure.

### DETAILED DESCRIPTION

Employing a coherent state or a quantum-enhanced Gaussian state in specially designed spatial modes has the potential to improve the precision of sensing a transverse beam displacement. Herein we describe the determination of a particular spatial mode provided, for example, by a laser system, for estimating a small transverse beam displacement, with the consideration of diffraction and confined apertures. We also describe a quantum-enhanced multi-spatial-mode transmitter, and a general two mode homodyne receiver that approaches a quantum Fisher information (QFI) based metric in the large mean photon number regime.

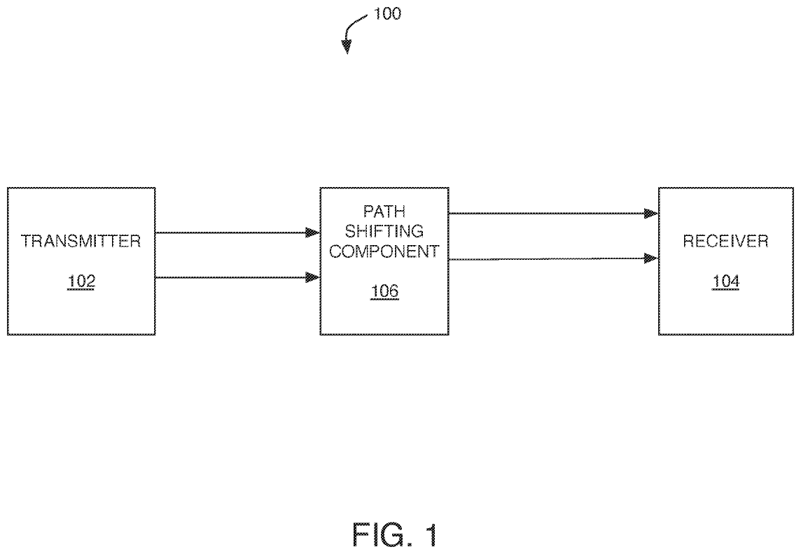

FIG. 1 shows an example sensing system 100 that includes a transmitter 102 that provides an optical beam from a transmitter aperture, and a receiver 104 that receives a portion of the optical beam at a receiver aperture. The optical beam passes through a path shifting component 106 that is part of the sensing system 100, and in some cases includes a target object that is being measured, observed, recorded, tracked, or otherwise sensed. In some cases, there is a subsystem that contains the target object and/or prepares the target object for sensing. A relatively small transverse displacement of the optical beam as it enters the receiver aperture can provide information to the receiver about the target object. With appropriate configuration of the transmitted optical beam from the transmitter 102, the sensitivity of the receiver 104 to small changes in that transverse displacement can be increased.

In some implementations, the sensing system 100 is configured to use the optical beam as a classical probe for measuring a property associated with an object or subsystem containing the path shifting component. In some configurations, the transmitter 102 and receiver 104 are configured as an “optimal classical transceiver,” which uses coherent light (e.g., laser light provided by a laser in the transmitter 102 or coupled to the transmitter 102) that is excited in an optimal spatial mode that comprises a finite set of orthogonal basis modes. As used herein, the term “optimal” applied to an example configuration may not necessarily indicate the best possible result achievable under any circumstances, but may provide an improvement over other possible configurations. Without being bound by theory, this disclosure describes analysis using quantum Fisher information (QFI) as an example of sensing a small transverse displacement of a beam. An example of an optimal receiver design is described that can be used with an optimal transmitter. An optimal receiver design can be implemented in any of a variety of forms. One example of a non-optimal transceiver implementation uses an image-plane (focal-plane) intensity measurement using arrayed signal shot-noise-limited detector pixels. An example of an optimal transmitter can achieve a four times better precision compared to using a traditional low order Hermite-Gaussian beam (i.e., laser light excited in the fundamental TEM00 mode) at a free-space Fresnel number product of the full system, D_{f}=90, as described herein. The precision advantage that can be achieved in beam displacement sensing can translate to a faster system for atomic force microscopy (AFM), for example, or can diminish other system constraints to achieve the same performance. The advantage of using the described transceiver techniques can be more significant when operating deeper near field systems (i.e., with larger D_{f} values).

In some implementations, the sensing system 100 is configured to use the optical beam as a quantum-enhanced probe for measuring a property associated with an object or subsystem containing the path shifting component. Prophetic examples of a quantum-enhanced transmitter described herein employ spatial-temporal entangled multi-mode squeezed-light. Based on certain assumed operating conditions, an optimal Gaussian state (e.g., a Gaussian state of a bosonic mode can be described as a quantum state of an optical wave that can be prepared using quadrature squeezed optical waves and passive linear optical elements) for distributing a single mode to the first M_{S} Hermite-Gaussian (HG) spatial modes is described. In one prophetic example, for D_{f}=90, |ϕ₃ [symbol] is an optimal choice for distributing a single mode Gaussian state to the first M_{S}=8 HG spatial modes. Additional prophetic examples are described that show that distributing a two mode state to the first M_{S} Hermite-Gauss spatial modes optimally (|ϕ₄ [symbol] ) will have a slight advantage over using |ϕ₃ [symbol] in the large total mean photon number regime.

Also described are two designs, each of which falls within the two categories respectively that are based on an optimal preparation circuit when diffraction loss is not included, |ϕ₁ [symbol] , |ϕ₂ [symbol] . They also capture a great portion of the maximum QFI. For D_{f}=90, and a total mean photon number of roughly 100 photons (over the entire integration time, and spread over the spatial modes allowed for by the diffraction-limited geometry), an example quantum enhanced transmitter could result in a 20% improvement in the root mean square error (RMSE) over and above an optimal classical transmitter.

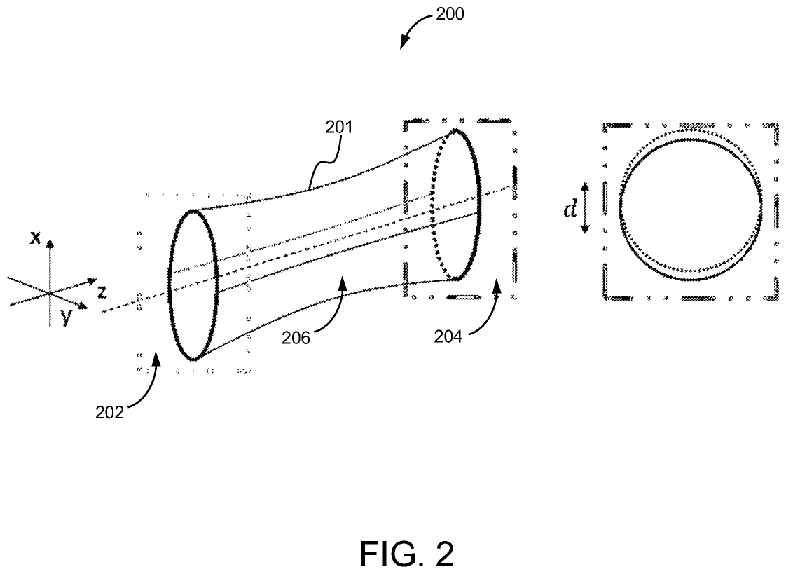

FIG. 2 shows a schematic diagram of an example transverse displacement along the x-axis. A beam 201 is sent through a transmitter aperture 202 to interact with a scene 206, and is thus no longer centered on a receiver aperture 204, but is carrying the information of the scene 206 on the transverse displacement d along the x-axis. In one example, angles of deflection may modify the analysis described herein. In other examples, the single parameter to be estimated is a small transverse displacement d along an axis.

The precision of estimating a single parameter is lower bounded by the inverse of quantum Fisher information (QFI), K(d). An optimal choice of measurement will have a classical Fisher information (CFI), J(d), saturating this lower bound. Processing the measurement result with maximum likelihood estimator (MLE) when it's unbiased, in the large trial number limit, has mean squared error (MSE) attaining the lower bound set by CFI:

$${min}_{\hat{ρ}} \frac{1}{K ( d )} \leq \frac{1}{J ( d )} \leq MSE ( d ) . \qquad ( 1 )$$

For this active sensing task, we will describe an optimal transceiver design that consists of an optimal Gaussian state, \hat{ρ}, with the consideration of diffraction loss by optimizing over QFI, then find an optimal receiver design that has CFI saturating the QFI. Although in some examples we may describe designs attaining optimal performance, specific design constraints may instead lead to improved, but not necessarily optimal, transceiver designs and Gaussian states.

In some examples, one may use probe states that are continuous variable Gaussian states, with which tools for theoretical analysis and experimental implementation are available.

We can separate the probe states into a classical transmitter, representing coherent states, and a quantum enhanced transmitter, representing the most general multi-mode Gaussian states, due to the complexity of probe state preparation. We have found that the classical optimal transmitter, preparing a coherent state in an optimal spatial mode which depends on channel geometry, has precision that surpasses the conventionally used HG-00 Gaussian mode with the same amount of resources, especially in the near field. The QFI of that optimal mode can be achieved by many receiver designs, some of which are shown in Table 1. We also present a quantum enhanced multi-partite Gaussian state probe, prepared in the span of the first eight normal modes of a Gaussian-soft-aperture propagation kernel, which achieves superior performance to the aforesaid optimal classical transmitter approximately by a factor of 1.5 in QFI, for D_{f}=90. The quantum probe can be highly sensitive to channel loss. For this specific probe, we present a two mode general Homodyne receiver that has CFI approaching the QFI in the large total mean photon number regime. We expect if the system geometry is in deeper near field, the advantage of quantum enhanced transmitter over classical optimal transceiver will be more prominent, whereas moving into far field, the quantum enhanced transmitter will gradually lose its advantage.

In this disclosure the performance of an optimal classical transceiver is presented in comparison with that of the HG00 transceiver from the following aspects: QFI, CFI and RMSE. Additionally, we describe a quantum enhanced transceiver design that outperforms an optimal classical transmitter in the near field and large N regime.

We first review the free space propagation of a setup with soft Gaussian apertures, then present the transverse displacement induced cross talk matrix and it's associated Hamiltonian in the near field regime, D_{f}>>1.

The system we analyze has well defined transmitter and receiver apertures. However, the eigen-modes for near field propagation with hard apertures do not have an explicit analytical form. In some implementations, numerical calculations may be used for systems with hard apertures, or with soft apertures that differ from Gaussian apertures. In order to demonstrate analytical calculations, we consider a line-of-sight system with Gaussian attenuated apertures. The Hermite-Gaussian (HG) spatial modes form a set of complete orthonormal spatial modes for the transverse field at each aperture respectively, and they provide a singular value decomposition of the free space propagation kernel for a well aligned transceiver setup with Gaussian attenuated apertures. Gaussian attenuated apertures may also suppress the diffraction ripple effect from hard apertures (e.g., coronagraphy). Each one of the HG spatial modes sent through the transmitter, propagated through free space, and collected by the receiver, will be in the same order HG spatial mode at the receiver plane. Since the HG basis has rectangular symmetry, we can consider the 1D component of it for demonstration purposes. The 1D component of the HG basis at the receiver side is,

$${ϕ}_{n} ( x , {w}_{R} ) = {( \frac{2}{π {w}_{R}^{2}} )}^{1 / 4} \frac{1}{\sqrt{n ! {2}^{n}}} {H}_{n} ( \frac{\sqrt{2} x}{{w}_{R}} ) \times exp [ - \frac{{x}^{2}}{{w}_{R}^{2}} + i \frac{k}{2 L} {x}^{2} ] , \qquad ( 2 )$$

$$for n = 0 , 1 , 2 , … ,$$

in which

$${w}_{R} = \frac{{r}_{R}}{{( 1 + 4 {D}_{f} )}^{1 / 4}} .$$

2r_{R} represents the width of the receiver aperture, which has a transmissivity.

$${D}_{f} = {( \frac{{kr}_{T} {r}_{R}}{4 L} )}^{2}$$

represents the Fresnel number product, k is the wave number and L is the distance between transmitter and receiver apertures.

The corresponding transmitter 1D HG basis shares the similar functional form,

$${Φ}_{n} ( {X}_{0} , {w}_{T} ) = exp \{ i \frac{( 2 n \vert 1 ) π}{4} - i \frac{k}{L} {x}_{0}^{2} \} {ϕ}_{n} ( {x}_{0} , {w}_{T} ) ,$$

in which x₀ represents the coordinate at the transmitter plane which is located at [symbol] =0. Free space propagation of HG spatial modes would suffer from diffraction loss,

$${\int }_{- ∞}^{∞} {\int }_{- ∞}^{∞} h ( ρ , {ρ}_{0} ) {Φ}_{n} ( {w}_{0} , {w}_{T} ) {Φ}_{m} ( {y}_{0} , {w}_{T} ) {dx}_{0} {dy}_{0} = \sqrt{{η}^{n + m + 1}} {ϕ}_{n} ( x , {w}_{R} ) {ϕ}_{m} ( y , {w}_{R} ) , \qquad ( 3 )$$

in which ρ₍₀₎=(x₍₀₎, y₍₀₎) represents the receiver (transmitter) aperture coordinates,

$$η = \frac{1 + 2 {D}_{f} - \sqrt{1 + 4 {D}_{f}}}{2 {D}_{f}}$$

is the transmissivity of the HG₀₀ mode, and D_{f} is the Fresnel number product, which in the near field regime is roughly the number of HG spatial modes that have near unity transmissivity. h(ρ, ρ₀) is the free space propagation kernel, given by

$$h ( ρ , {ρ}_{0} ) ≡ cxp ( - \frac{{\vert ρ \vert}^{2}}{{r}_{R}^{2}} ) \times \frac{exp ( ikL + ik {\vert {ρ}_{0} - ρ \vert}^{2} / 2 L )}{i λ L} exp ( - \frac{\vert {ρ}_{0} {\vert}^{2}}{{r}_{T}^{2}} ) . \qquad ( 4 )$$

The first and third terms are the receiver and transmitter Gaussian apertures respectively, and the second term is the Fresnel propagation kernel.

Our analysis accounts for diffraction losses accurately, but models the transmitter's optical source as well as all the receiver-side optics (collection optics, spatial mode sorter, and homodyne detection) to be ideal. We focus on the loss coming from free space propagation as losses from other sources can be included more easily, due to the fact that they tend to act equally for different spatial modes, e.g. the detectors intrinsic inefficiency. Assuming the direction of d is known from some previous measurement results and aligning it with x-axis, we keep the y direction modal component to be the lowest order for the minimal amount of diffraction loss. There will be \sqrt{2D_{f}} modes in the aforementioned subset of HG modes that have near unity transmissivity.

When the n0-th HG spatial mode, Φₙ(x₀,w_{T})Φ₀(y₀, w_{T}), is excited at the transmitter, the field entering the receiver aperture is

$${u}_{n} ( x , y ) = \sqrt{{η}^{n + 1}} {ϕ}_{n} ( x , {w}_{R} ) {ϕ}_{0} ( y , {w}_{R} ) \times exp ( \frac{\vert ρ {\vert}^{2}}{{r}_{R}^{2}} ) \qquad ( 5 )$$

The last exponential term takes the field exiting the receiver aperture back to before it passes through the receiver aperture. When the field carries a transverse displacement along the x-axis after interacting with the scene, the field entering the receiver aperture becomes uₙ(x+d, y). The field emerging from the receiver aperture is

$${u}_{n} ( x + d , y ) exp ( - \frac{\vert ρ {\vert}^{2}}{{r}_{R}^{2}} ) .$$

The crosstalk matrix, [symbol] in the small transverse displacement limit, which is a tri-diagonal matrix, is described later in this disclosure. The square of the elements of the crosstalk matrix represent fractional power transfer induced by d along the x-axis from ϕₙϕ₀ to {ϕₙ₋₁ϕ₀, ϕₙϕ₀, ϕₙ₊₁ϕ₀}. The x-axis herein is used merely for description purposes. Displacement may occur along any axis, or more than one axes, which may be accounted for in the setup of the system and the subsequent analysis.

For the classical transmitter, we will use the crosstalk matrix [symbol] to determine an optimal spatial mode in which to prepare a coherent state at the transmitter. Even though the HG00 mode is the most energy conserving spatial mode for free space propagation, using higher order spatial modes can have substantial improvement over the HG00 mode for D_{f}>>1. For a quantum transmitter, we find a continuous variable multi-partite entangled state that shows further enhancement over the classical optimal transmitter. For a symmetric setup, r_{R}=r_{T}, in the large Fresnel number product regime, D_{f}>>1, the crosstalk matrix is approximately a skew Hermitian matrix, as shown in equation 47. Thus the parameter encoding action can be modeled as a unitary transformation, Û(d)=exp{−α^{†}ln ( [symbol] )\dot{\hat{α}}},in which

$$\tilde{d} = \frac{d}{{r}_{R}}$$

is the normalised transverse displacement. The whole process of diffraction loss and parameter encoding can be modeled as a Trace Preserving, Completely Positive (TPCP) map from the state at the transmitter side HG spatial mode to the states in the receiver side HG spatial mode.

A coherent state the quantum description of ideal laser-light radiation is always single mode in some basis. By optimizing the QFI function, we determine an optimal spatial mode to excite a coherent state in that achieves optimal precision for sensing d. Gaussian states can be fully specified with the mean and covariance matrix in a certain set of modes (e.g., HG spatial modes). For coherent states one only need to specify the mean vector. We excite a coherent state in the first M_{S} HG spatial modes, keeping the y component being 0-th order. This state can be represented with a 2M_{S} vector,

$${\vec{a}}_{2 {M}_{S}}^{T} = \sqrt{N} ( {a}_{0} cos {θ}_{0} , {a}_{1} cos {θ}_{1} , … , {a}_{0} sin {θ}_{0} , {a}_{1} sin {θ}_{1} , … ) .$$

(\sqrt{N}αₙ, θₙ) represents the amplitude and phase of n0-th HG mode at the transmitter. N is the total mean photon number of this coherent state at the transmitter. {αₙexp(iθₙ)} are the normalised coefficients. After experiencing free-space propagation and picking up the transverse displacement, at the receiver aperture plane and with respect to the receiver HG spatial modes, the state is still a multi-mode coherent state in the receiver HG basis, with a mean vector α̅_{d̅}= [symbol] ·(η̅_{2M}_{_{S}}×α̅_{2M}_{_{S}}), where [symbol] is the crosstalk matrix in terms of the mean vector, and η̅_{2M}_{_{S}}=(\sqrt{η}, η, . . . , η^{M}^{_{S}}^{/2}, \sqrt{η}, η, . . . , η^{M}^{_{S}}^{/2}).

Since a coherent state is a pure state, the fidelity is

$${ℱ ( ε ) = \vert 〈 ϕ ( \tilde{d} ) \vert ϕ ( \tilde{d} + ε ) 〉 \vert}^{2} , = exp \{ - {\vec{a}}_{\tilde{d}} \cdot {\vec{a}}_{\tilde{d}} - {\vec{a}}_{\tilde{d} + ε} \cdot {\vec{a}}_{\tilde{d} + ε} + 2 {\vec{a}}_{\tilde{d}} \cdot {\vec{a}}_{\tilde{d} + ε} \} . \qquad ( 6 )$$

For a symmetrical setup, r_{T}=r_{R}, the QFI for d̅=d/r_{R} is

$${K}_{c} ( \tilde{d} ) = - 2 \frac{{\partial }^{2} ℱ ( ε )}{\partial {ε}^{2}} \vert ε \to 0 , = 16 η N ( {\sum }_{j = 0}^{{M}_{S} - 1} ( j + ( 2 j + 1 ) {D}_{f} ( 1 - η ) ) {η}^{j} {a}_{j}^{2} - η \times {\sum }_{j = 0}^{{M}_{S} - 3} \sqrt{4 ( j + 1 ) ( j + 2 ) {D}_{f}} {η}^{j} {a}_{j} {a}_{j + 2} sin ( {θ}_{j} - {θ}_{j + 2} ) ) . \qquad ( 7 )$$

Equation 7 shows the QFI of a classical transmitter, K_{c}(d̅), as a function of the transmitted coherent state, α̅_{2M}_{ₛ} and D_{f}. The dependence of K_{c}(d̅) on system geometry boils down to the dependence of the system's Fresnel number product. With a classical transmitter, the QFI can only have a linear scaling to N. Thus we focus on finding an optimal spatial by setting N=1 for the optimization in this section. From this function it is clear that the higher order spatial modes are more sensitive to beam displacement but they are also more lossy. In order to maximize K_{c}(d̅), one apparent choice of the phases would be

$${θ}_{n} = \frac{n π}{4} .$$

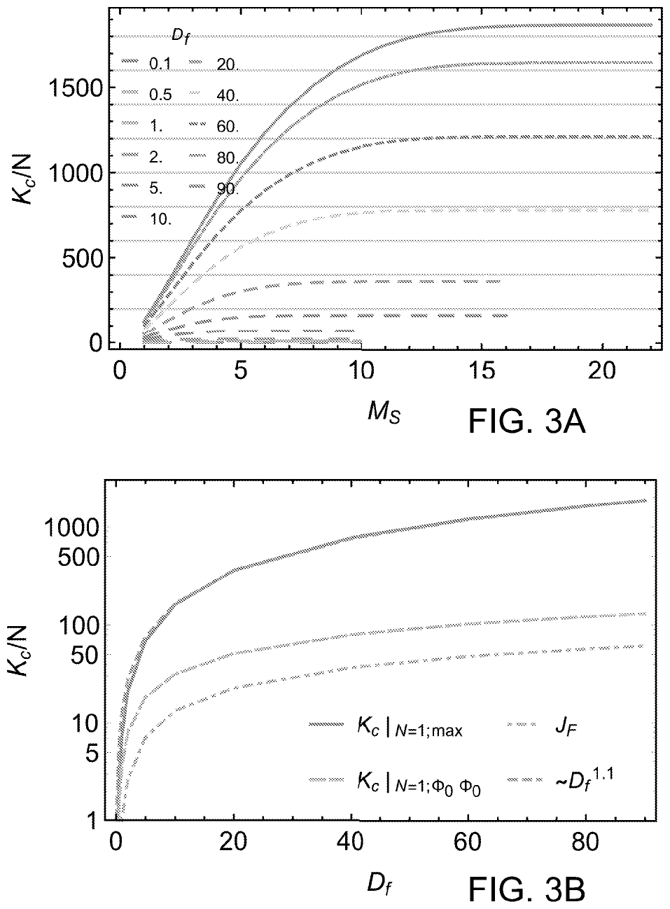

An optimal K_{c}(d̅) given N=1, for a certain D_{f} and M_{S}, can be obtained by setting α̅_{2M}_{_{S}}^{T}·α̅_{2M}_{_{S}}=1 and maximizing Equation 7 over all M_{S} amplitudes using Lagrange multipliers. This leads to the results shown in FIG. 3A. For a setup with a specific D_{f}, the QFI improvement of including more spatial modes saturates, resulting in an optimal mode shape to excite and the corresponding maximum QFI, K_{c}(d̅)|_{N=1;max}.

K_{c}(d̅)|_{N=1;max} for several D_{f} is shown in FIG. 3B, together with the QFI of using 00-th HG mode given N=1 (K_{c}(d̅)|_{N=1;HG}_{₀₀}). For D_{f} around 60, which is in the near field propagation regime (i.e. D_{f}>>1.), the QFI achievable by optimal classical transmitter is more than 10 times better than the QFI achievable with coherent state in 00-th HG mode. This advantage could enable a faster system, such that the same precision can be obtained more than 3 times faster or consume 3 times less energy with the rest resources kept the same. In deeper near field, this advantage would be more significant. The dashed line in FIG. 3B shows the asymptote, 13.2D_{f}^{1.1} of K_{c}(d̅)|_{N=1;max}, leading to a good rule of thumb for the precision of an optimal classical

TABLE 1
Classical transceiver designs.

| | Transmitter | Receiver | QFI attaining |
|---|---|---|---|
| Transceiver A | Z(x)Φ₀(y) | HGSPADE-DD | Yes |
| Transceiver B | Z(x)Φ₀(y) | ζ-SPADE-DD | Yes |
| Transceiver C | Z(x)Φ₀(y) | HGSPADE- | Yes |
| | | Homodyne | |
| Transceiver D | Z(x)Φ₀(y) | ζ-Homodyne | Yes |
| Transceiver E | Φ₀(x)Φ₀(y) | HGSPADE-DD | Yes |
| Transceiver F | Φ₀(x)Φ₀(y) | ARRAY-DD | No |

transmitter for D_{f}∈(0, 90],

$$Δ d {\approx }^{>} \frac{{r}_{R}}{\sqrt{13.2 {D}_{f}^{1.1} N}} . \qquad ( 8 )$$

By inserting α̅₂^{T}=(1,0) into Eq.7, we get the QFI for using only the HG00 mode,

$$\frac{2 {( \sqrt{1 + 4 {D}_{f}} - 1 )}^{3}}{{D}_{f}} ,$$

such that the corresponding precision limit is

$$Δ d \geq \frac{{r}_{R} \sqrt{{D}_{f}}}{\sqrt{2 {( \sqrt{1 + 4 {D}_{f}} - 1 )}^{3} N}} . \qquad ( 9 )$$

In the limit of large D_{f}, the above equation approaches r_{R}/{square root over (16\sqrt{D_{f}}N)}. In FIG. 3B, the line labeled J_{F} shows the classical Fisher information of using transceiver F, which represents the performance of a conventional transceiver design.

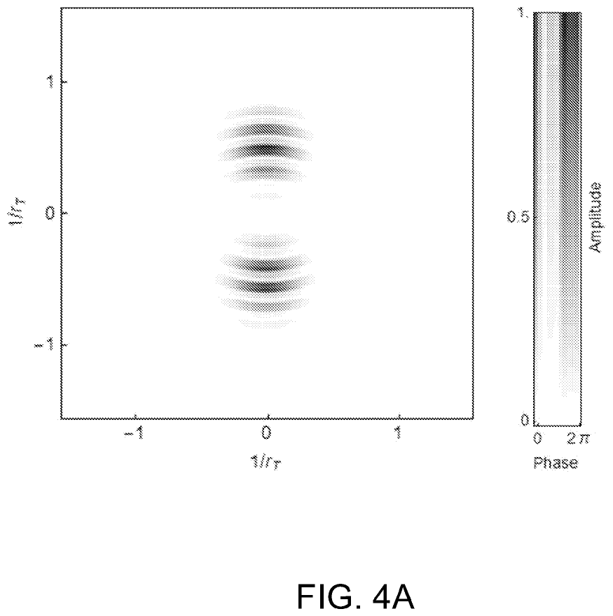

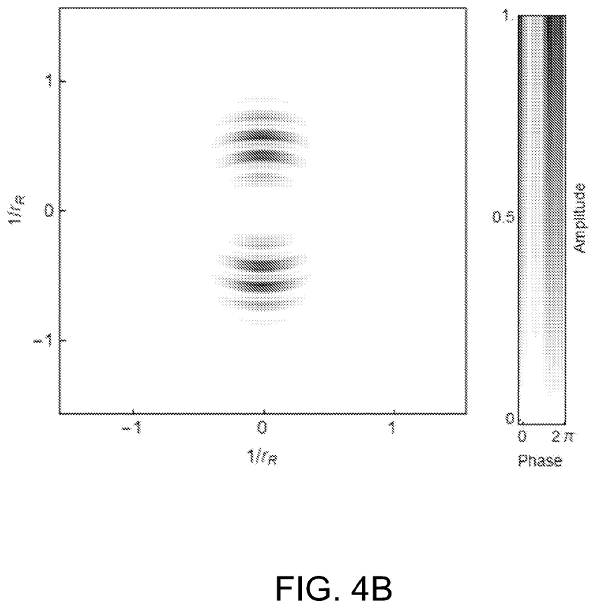

Herein we describe five different receiver designs, in which the first four of them are QFI attaining:
1. HG-SPADE-DD: HG mode spatial demultiplexing followed by PNR detection on each mode. Spatial mode demultiplexing (i.e. spatial mode sorting) can be performed with systems containing spatial light modulators, or by other means.
2. ζ-SPADE-DD: ζ-SPADE separating ζ(x)ϕ₀(y), followed by a single PNR detector. For D_{f}=90, an optimal spatial mode ζ(x,D_{f})ϕ₀(yw_{R}) is shown in FIG. 4B.
3. HG-SPADE-Homodyne: HG-SPADE followed by multimode Homodyne detection in as many HG spatial modes as needed.
4. ζ-Homodyne: Single mode Homodyne detection in ζ(x)ϕ₀(y).
5. ARRAY-DD: Arrayed direct detection with infinitesimal pixels array and 100% fill factor.

The first four receiver designs have the potential to attain QFI, such as for the two transmitters we describe herein: an optimal classical transmitter and 00-th HG mode classical transmitter. The six transceiver designs that we consider are listed in Table 1. The last column of Table 1 shows if a receiver design is QFI attaining, which indicates if it is an optimal receiver for the corresponding transmitter. For the first four receiver designs we will analyze the case of an optimal classical transmitter, which excites a coherent state in Z(x)Φ₀(y) mode, and show they are QFI attaining. For the last receiver design, ARRAY-DD, we will focus on the 00-th HG mode.

FIG. 4A shows the saturated optimal spatial mode at the transmitter for D_{f}=90, Z(x, 90)Φ₀(y). For D_{f}=90, exciting a coherent state in Z(x, 90)Φ₀(y) will have optimal precision in d estimation. An optimal spatial mode is an odd function of x, although there exists an even spatial mode that achieves a comparable QFI. The D_{f} dependence can be omitted for simplification of representation.

An optimal classical transmitter excites a coherent state in the saturated optimal spatial mode found based on QFI optimization,

$$Z ( x , {D}_{f} ) {Φ}_{0} ( y , {w}_{T} ) = {\sum }_{n = 0}^{{M}_{S} / 2 - 1} {α}_{2 n + 1} {e}^{in π / 2} {Φ}_{2 n + 1} ( x , {w}_{T} ) {Φ}_{0} ( y , {w}_{T} ) . \qquad ( 10 )$$

with a total mean photon number N, in which α₂ₙ₊₁ are the optimized coefficients of the 2n+1, 0-th HG spatial modes. At the receiver, we account for the modal crosstalk captured by matrix [symbol] . The received field is

$$\sqrt{N} {\sum }_{n = 0}^{{M}_{S} / 21} {α}_{2 n + 1} {η}^{n + 1} {e}^{in π / 2} {ϕ}_{2 n + 1} ( x , {w}_{R} ) {ϕ}_{0} ( y , {w}_{R} ) + \sqrt{N} \tilde{d} {\sum }_{n = 0}^{{M}_{S} / 2 - 1} {β}_{2 n} {e}^{i ( {ϑ}_{2 n} + {ϑ}_{0} )} {ϕ}_{2 n} ( x , {w}_{R} ) {ϕ}_{0} ( y , {w}_{R} ) . \qquad ( 11 )$$

An optimal receiver design can generally depend on the parameter to be estimated. However, d̅ is embedded in the amplitudes of even order HG modes, such that the receiver design for a small d̅ does not depend on the actual transverse displacement.

Classical Fisher information quantifies the precision of a certain measurement. Cramer-Rao bound serves as a good lower bound when we have an unbiased estimator,

$$Δ d \geq \frac{1}{\sqrt{vJ ( d )}} , \qquad ( 12 )$$

in which ν is the number of trials available. When a specific measurement is applied to the information bearing light, the probability distribution of the measurement outcome given the value of parameter, P(γ̅; d̅), can be used to calculate J(d), in which γ̅ represents the vector composed of random variables associated with the measurement outcomes. For a continuous random variable, the CFI is

$$J ( \tilde{d} ) = \int {( \frac{\partial P ( \vec{γ} ; \tilde{d} )}{\partial \tilde{d}} )}^{2} \frac{1}{P ( \vec{γ} ; \tilde{d} )} d \vec{γ} , \qquad ( 13 )$$

The CFI for discrete random variables can be easily modified from Eq. 13.

In the following paragraphs, the CFI of each receiver design is analysed. The first four receivers are QFI attaining, which indicates that the CFI is approximately equal to the QFI for those receivers. The last one is a widely used receiver in the imaging context, which can be readily implemented though is not necessarily QFI attaining for both an optimal classical transmitter and the 00-th HG transmitter. For demonstration purposes, the mode sorters are assumed to be ideal and lossless, and the homodyne detection and direct detection are assumed to be ideal. Non-idealities can also be accounted for in the design of the transceivers we propose.

HG-SPADE DD is composed of a mode sorter capable of HG spatial mode demultiplexing, and many PNR detectors collecting photons for each of the HG spatial modes. This is a QFI attaining receiver design for classical transmitter with Z(x)Φ₀(y) and also Φ₀(x)Φ₀(y). Since the transverse displacement is embedded in the amplitudes of HG modes, the relative phase does not carry information about it. The probability of direct detection on each HG spatial mode will result in a series of independent random variables each following a corresponding Poisson distribution,

$${P}_{D} ( \vec{γ} ; \tilde{d} ) = {\prod }_{j = 0}^{{M}_{S} - 1} {P}_{j} ( {γ}_{j} ; \tilde{d} ) , \qquad ( 14 )$$

in which Pⱼ(γⱼ; d̅) represents the probability density function of the direct detection outcome on the j0-th HG mode. For the classical optimal transmitter, the parameter is embedded in the even mode's amplitude, each of them having a mean photon number N₂ₙ=β₂ₙ²d̅²N. The CFI for discrete independent random variables can be modified as

$$J ( \tilde{d} ) = {\sum }_{j = 0}^{{M}_{S} - 1} {\sum }_{k = 0}^{∞} {( \frac{\partial {P}_{j} ( {γ}_{j} = k ; \tilde{d} )}{\partial \tilde{d}} )}^{2} \frac{1}{{P}_{j} ( {γ}_{j} = k ; \tilde{d} )} , \qquad ( 15 )$$

in which Pⱼ(γⱼ=k; d̅) means the probability of the photon counting result being k for the j0-th HG mode. For Poisson distributions, the CFI can be further simplified into,

$$J ( \tilde{d} ) = {\sum }_{j = 0}^{{M}_{S} - 1} {( \frac{\partial {N}_{j}}{\partial \tilde{d}} )}^{2} \frac{1}{{N}_{j}} , \qquad ( 16 )$$

An optimal classical transmitter combined with an HG-SPADE DD receiver will have J(d̅)=4NΣₙ₌₀^{M}^{_{S}}^{/2}β₂ₙ², which saturates the QFI of an optimal classical transmitter. It can be verified that for transmitter employing 00-th HG mode, this receiver design is also QFI attaining. Thus transceiver A and E, listed in Table 1, both have the best possible receiver design for the corresponding transmitter.

The ζ-SPADE DD receiver first separates ζ(x)ϕ₀(y) from the received beam, then a photon counting measurement is performed on this specific mode, in which the x component is,

$$ζ ( x , {D}_{f} ) = \frac{1}{\sqrt{{\sum }_{n = 0}^{{M}_{S} / 2} {β}_{2 n}^{2}}} {\sum }_{n = 0}^{{M}_{S} / 2} {β}_{2 n} {e}^{i ( {ϑ}_{2 n} + {ϑ}_{0} )} {ϕ}_{2 n} ( x , {w}_{R} ) , \qquad ( 17 )$$

This is a normalised spatial mode at the receiver plane that depends on the D_{f} of the system, one example of which is shown in FIG. 4B. For an optimal classical transmitter, d̅ is encoded in the amplitude of ζ(x)ϕ₀(y). Thus, for D_{f}=90, performing single mode Homodyne detection or single mode DD in ζ(x, 90)ϕ₀(y, w_{R}), with the x-component shown in FIG. 4B, will saturate QFI for an optimal classical transmitter. The photon counting outcome is a random variable following the Poisson distribution with a mean N_{ζ}=Nd̅²Σₙ₌₀^{M}^{_{S}}^{/2}β₂ₙ². It is straightforward to verify that the ζ-SPADE DD receiver is a QFI attaining receiver for an optimal classical transmitter. For a transmitter employing the 00th HG mode, the ζ-SPADE-DD receiver converges to the HG-SPADE-DD receiver.

The HG-SPADE Homodyne receiver will pass the received beam through a HG mode demultiplexer, then perform Homodyne detection on each of the HG modes. Certain phases are applied to each of local oscillators to maximize the real quadratures. This is also a QFI attaining receiver design. The measurement outcomes follow independent Normal distributions with the mean given by the corresponding HG modes' amplitudes and a variance of ¼.

$${P}_{H} ( \vec{γ} ; \tilde{d} ) = {\prod }_{j = 0}^{{M}_{S} - 1} {P}_{j} ( {γ}_{j} ; \tilde{d} ) , \qquad ( 18 )$$

The resulting CFI obtained with Equation 13 for optimal classical transmitter is a function of the even order HG modes' amplitude,

$$J ( \tilde{d} ) = 4 {\sum }_{n = 0}^{{M}_{S} / 2} {β}_{2 n}^{2} . \qquad ( 19 )$$

Which is the same as Equation 7 by using a coherent state in Z(x,D_{f})ϕ₀(y,w_{T}) spatial mode.

The ζ-Homodyne receiver is a single mode homodyne detector with the local oscillator in the spatial mode ζ(x, D_{f})ϕ₀(y, w_{R}). This receiver is in the same spirit as ζ-SPADE DD receiver, which also saturates the QFI for optimal classical transmitter. The local oscillator should be set in phase with the received beam. Thus with the amplitude of the received beam in this specific spatial mode, the amplitude of the corresponding HG spatial modes can be obtained accordingly, which leads to a CFI of the same form as Equation 19.

For rank-deficient states, an optimal receiver design is not unique. In such cases, the symmetric logarithmic derivative (SLD) gives one of the receiver designs attaining QFI. The SLD for an optimal classical transmitter shows ζ-Homodyne can attain the QFI.

An example of the Arrayed-DD receiver is an ideal camera, which has infinitesimal pixels, 100% fill factor, and is limited by Poisson noise. Other examples of the Arrayed-DD receiver can account for non-idealities. A camera receiver does not require knowledge of a well defined coordinate axis nor, in some sense, the position of the origin. Additionally, this receiver design is compact. We focus on the analysis of this receiver design with the HG00 mode transmitter, which together comprise transceiver F. A split detector can be considered as a simplified version of arrayed detector with a 2×2 pixelation. In this section we analyze an arrayed detector with infinitesimal pixels, thus setting an optimal CFI for this class of receivers. Using an ARRAY-DD receiver with finite size over the same area will have a CFI approaching this limit with the decrease of pixel size.

For a transmitter with a coherent state in Φ₀(x)Φ₀(y), with total mean photon number N, the received mode carrying a small transverse displacement along the x-axis is (\sqrt{η}ϕ₀(x)+c₁dϕ₀(x))ϕ₀(y), with total mean photon number N. This is the most energy conserving spatial mode for free space propagation through a soft aperture setup. DD results in infinitely many Poisson distributed random variables, and the mean value of them are,

$${N}_{i} ( x , y ; \tilde{d} ) = N {\vert \sqrt{η} {ϕ}_{0} ( x ) + {c}_{1} \tilde{d} {ϕ}_{1} ( x ) \vert}^{2} {\vert {ϕ}_{0} ( y ) \vert}^{2} dxdy , \qquad ( 20 )$$

where Nᵢ indicates the total mean photon number for infinitesimal pixels. Then the classical Fisher information for a small d̅ is,

$$\begin{matrix}J ( \tilde{d} ) = {lim}_{\tilde{d} \to 0} \int \int {( \frac{\partial {N}_{i} ( x , y ; \tilde{d} )}{\partial \tilde{d}} )}^{2} \frac{1}{{N}_{i} ( x , y ; \tilde{d} )} , \\ = N \int \frac{{[ {c}_{1} {ϕ}_{1} ( x ) {ϕ}_{0}^{*} ( x ) + {c}_{1}^{*} {ϕ}_{1}^{*} ( x ) {ϕ}_{0} ( x ) ]}^{2}}{{\vert {ϕ}_{0} ( x ) \vert}^{2}} dx .\end{matrix} \qquad ( 21 )$$

The integration goes over the area covered by the camera. This CFI with transceiver F, as a function of D_{f}, is shown in FIG. 3B as the line labelled J_{F}. This receiver is not QFI attaining.

The corresponding linear maximum likelihood estimator is unbiased only in the limit of d approaching 0. The small d limit is used for analytic simplicity, although larger d values can be determined with modifications.

$${lim}_{d \to 0} \{ {min}_{\hat{ρ}} \frac{1}{K ( d )} = \frac{1}{J ( d )} = MSE ( {\hat{d}}_{ML} ) \} . \qquad ( 22 )$$

By running Monte Carlo simulation of the measurement results on transceiver A, B, E and F, and using modified maximum likelihood estimation Method (MLE) to process the simulated measurement results, then comparing the performance of transceiver A and B with transceiver E and F based on bias, standard deviation and RMSE, we find that transceiver A has the potential of high precision and large dynamic range at the expense of long response time, transceiver B has high precision but may be inherently limited to a small dynamic range, and the precision of transceivers E and F may be worse, with the same amount of resource.

In this section we will first review the MLE method, then show the mean and standard deviation of the simulated results. At last we will show, with an unbiased and most efficient choice of estimator, that the RMSE of the estimation results attain the corresponding QFI for transceivers A, B, and E.

When a set of measurement results are available, the estimator according to maximum likelihood estimation (MLE) is constructed by maximizing the probability density distribution function with respect to d for this given set of measurement outcome,

$${\hat{d}}_{ML} ( \vec{γ} ) = MaxargP ( \vec{γ} , \tilde{d} ) , \qquad ( 23 )$$

Maximizing the log-likelihood function can simplify the maximization process. When one copy of the scene is available, e.g., when we only use a single temporal mode, for transceiver A, the measurement outcomes are independent Poisson distributed random variables, and maximizing the log likelihood function is equivalent to,

$$\begin{matrix}{\hat{d}}_{ML} ( \vec{γ} ) = Maxarg log [ {\prod }_{j = 0}^{{M}_{S} - 1} {P}_{j} ( {γ}_{j} ; \tilde{d} ) ] \\ = Maxarg {\sum }_{j = 0}^{{M}_{S} - 1} [ - {N}_{j} + {γ}_{j} log {N}_{j} - log {γ}_{j} ! ] , \\ = Maxarg {\sum }_{j = 0}^{{M}_{S} - 1} [ - {N}_{j} + {γ}_{j} log {N}_{j} ] .\end{matrix} \qquad ( 24 )$$

The Nⱼ's are functions of d̅ but the measurement outcomes are not, thus the third term can be discarded. When ν copies of the scene are available, e.g., when the number of temporal spatial mode employed is M_{T}, one can maximize the

$${\hat{d}}_{ML} ( {}^{1} \vec{γ} , {}^{2} \vec{γ} , … , {}^{v} \vec{γ} ) = Maxarg {\sum }_{j = 0}^{{M}_{S} - 1} [ - {N}_{j} + log {N}_{j} {\sum }_{l = 1}^{v} \frac{{}_{}^{l} {γ}_{j}}{v} ] , \qquad ( 25 )$$

in which ^{v}\vec{γ} is the measurement outcome of the ν-th temporal mode. The MLE merit function can be easily modified for Transceiver B and E. For transceiver F, we simulate the performance of a 1×2 split detector with the center portion of the received beam, 5r_{R}×5r_{R}, extending over a 500×500 pixelated camera. An ideal camera with 100% fill factor is assumed. The detector is separated into two parts to estimate the transverse displacement along x-axis.

When the estimator is constructed only depending on d̅ up to the quadratic term, the transceiver A and B are proven to provide better precision than transceiver E, especially when the true value of d̅ is small. For a setup with D_{f}=90, an optimal classical transmitter using a mean total amount of photons over some continuous time, N=10¹¹, 1000 trials were ran for each true value of d={0.001,0.005, 0.01, 0.05, 0.1}. For d̅=0.001, the performance of transceiver A and B are the same. The estimators are unbiased with high precision. These MLE estimators are no longer unbiased for d̅>0.001. For small displacement values, the standard deviations of different transceiver designs agree with our QFI and CFI analysis. Transceiver F can operated with small d̅ performance, as the measurement outcome can be pre-processed to be accurate to pixel level, 0.01 r_{R} for our case.

When we construct MLE estimators with Nⱼ's that are accurate to higher order terms of d̅, the estimators for transceiver A and E can be unbiased for a larger dynamic range as the HG spatial mode decomposition is unique for any spatial mode.

The calculated precision improvement is in agreement with the QFI and CFI analysis done with the assumption that d is small. With more accurate Nⱼ functions, the dynamic range for transceiver A can be expanded at the expense of longer data processing time. The dynamic range for transceiver B is confined to a small region, since the energy that goes into ζ(x, 90)ϕ₀(y) is degenerate to more than one d values, inherently limiting the dynamic range. When we already know d̅≤0.04, transceiver B can provide an accurate measurement. In order to have an unbiased estimator for d̅≤0.01, we need to have the received field accurate to d̅⁵. Transceiver B can be accompanied with some low precision method to first calibrate the origin back into the dynamic range of transceiver B if multiple copies of the same or similar scenes are available.

For d̅≤0.01, in one example calculation, we choose the field dependence to be accurate up to d̅⁷ for transceiver A, up to d̅⁵ for transceiver B, up to d̅⁵ for transceiver E and up to d̅⁵ for transceiver F to collect estimation data for N varies from 10⁵ to 10 ¹¹. We have calculated the RMSE of the estimation data for d̅=0.001. From the calculation we, find that transceiver E, A and B are all QFI attaining. The performance of transceiver A and B is approximately 3.8 times better than transceiver E. Transceiver F is not QFI attaining. For d̅={0.005,0.01}, all four receivers have same level of precision as the precision for d̅=0.001 correspondingly.

In this section a quantum enhanced receiver is described. The diffraction loss in a system can be modeled as a series of beam splitters (BS) acting on each one of the HG modes, with the transmissivity of each BS forming a geometric sequence with p as the common ratio, and each free port being in vacuum. The parameter encoding can be modeled as a passive unitary transformation. For a symmetric setup, r_{R}=r_{T}, in the large Fresnel number product regime, D_{f}>>1, the parameter encoding action can be modeled as, Û(d̅)=exp{−\overline{\hat{α}}^{†}ln( [symbol] )\overline{\hat{α}}}=exp{−id̅Ĥ}, in which

$$\tilde{d} = \frac{d}{{r}_{R}}$$

is the normalised transverse displacement and the Hamiltonian is

$$\hat{H} = {( 4 {D}_{f} )}^{1 / 4} {\vec{\hat{a}}}^{†} ( - i Γ + \vert Γ \vert ) \vec{\hat{a}} . \qquad ( 26 )$$

This Hamiltonian captures the same effect that higher order HG spatial modes enable a stronger response to transverse displacement.

We now describe a type of multi-mode pure Gaussian state that provides an optimal precision under a total mean photon number constraint for sensing a small transverse displacement. To construct a multi-mode general pure Gaussian state in the HG basis, the Williamson's theorem and the Euler decomposition are used. The operator \hat{b} represents the M_{S} mode product state, each of which are allowed to be in a displaced squeezed state. The Û₀ represents the M_{S} mode general passive unitary operation. We use an analytical form of the universal passive unitary transformation. With the general representation of a multi-mode pure Gaussian state, and the analytical formula of the fidelity between any two Gaussian states, we construct an optimization with the QFI function, leading to an optimal Gaussian state.

We can decompose Û(d̅) into parameter independent passive unitary matrices and M_{S}/2 path-symmetric pairwise Mach-Zehnder interferometers (MZIs) depending on d̅. With this knowledge, we will analyse the QFI when the diffraction loss is ignored, which will serve as an unattainable upper bound. Then, we present an optimal multi-mode Gaussian state living in the span of HG modal basis, that has the best precision for sensing d̅ considering diffraction loss and a Gaussian receiver design.

Γ as a real skew symmetric matrix, can be put in a block diagonal form with some orthogonal transformation. For an M_{S} mode problem, we have

$$TR ( Γ + i \vert Γ \vert ) {R}^{†} {T}^{T} = \sqrt{2} {⊕}_{n = 1}^{\vert {M}_{S} / 2 \vert} i {σ}_{y} {λ}_{n} , \qquad ( 27 )$$

R is a diagonal matrix with diagonal elements,

$${R}_{nn} = exp \{ \frac{i π}{4} n \} .$$

Thus \hat{R} is composed of single mode phasers. T is an orthogonal transformation that can be realized with some passive unitary transformation. σ_{y} is the Pauli Y operator. λₖ are real numbers with ±λₖ being the eigenvalues of Γ and λₖ are ordered decreasingly. The Hamiltonian can be simplified in the form,

$$\begin{matrix}\hat{H} = - i 2 {( {D}_{f} )}^{1 / 4} {\vec{\hat{a}}}^{†} {R}^{†} {T}^{T} ( {⊕}_{n = 1}^{⌈ {M}_{S} / 2 ⌉} i {σ}_{y} {λ}_{n} ) TR \vec{\hat{a}} \\ = - i {\vec{\hat{a}}}^{†′} ( {⊕}_{n = 1}^{⌈ {M}_{S} / 2 ⌉} i {σ}_{y} {ε}_{n} ) {\vec{\hat{a}}}^{′} \\ = 2 {\sum }_{n = 1}^{{M}_{S} / 2} {ε}_{n} {\hat{S}}_{y}^{2 n - 1}\end{matrix} . \qquad ( 28 )$$

in which \overline{\hat{α}}′=TR\overline{\hat{α}} and εₙ=2(D_{f})^{1/4}λₖ. Then in the basis of \overline{\hat{α}}′, the transverse beam displacement is composed of M_{S}/2 parallel path-symmetric pairwise MZIs for the neighboring modes.

Û(d̅) is a series of MZIs for the states in the neighboring HG basis. With a change of modal basis, the parameter encoding unitary is effectively a series of pairwise path-symmetric MZIs for the neighboring modes in this new set of basis, with phase difference 2d̅εₖ between the two arms.

For indefinite photon number states, particularly Gaussian states, an optimal state for single parameter embedded in a multimode passive unitary transformation is a single mode squeezed vacuum put into the correct spatial mode. The unitary matrix representing the transverse displacement in HG spatial mode is

$$U ( \tilde{d} ) = {R}^{†} {T}^{T} {⊕}_{k = 1}^{⌈ {M}_{S} / 2 ⌉} ( \begin{matrix}cos ( \tilde{d} {ε}_{k} ) & sin ( \tilde{d} {ε}_{k} ) \\ - sin ( \tilde{d} {ε}_{k} ) & cos ( \tilde{d} {ε}_{k} )\end{matrix} ) TR , \qquad ( 29 )$$

The corresponding generator of this circuit is,

$$\begin{matrix}{g}_{d} = {iU}_{d}^{†} \frac{{dU}_{d}}{dd} \\ = {R}^{†} {T}^{T} {⊕}_{k = 1}^{⌈ {M}_{S} / 2 ⌉} ( i {ε}_{k} {σ}_{y} ) TR\end{matrix} , \qquad ( 30 )$$

Then the generator is diagonalized by

$$V = {R}^{†} {T}^{T} {⊕}_{k = 1}^{⌈ {M}_{S} / 2 ⌉} \hat{B} \qquad ( 31 )$$

such that g_{d}=Vε_{d}V^{†}.

$${ε}_{d} = 2 {iD}_{f}^{1 / 4} diag ( {λ}_{1} , - {λ}_{1} , … , {λ}_{{M}_{S} / 2} , - {λ}_{{M}_{S} / 2} ) \qquad ( 32 )$$

An optimal Gaussian state in HG basis is,

$${{{\vert {φ}_{1} 〉 = \hat{V} \vert 0 ; r 〉}_{1} \vert 0 〉}_{2} … \vert 0 〉}_{{M}_{S}} . \qquad ( 33 )$$

An optimal Gaussian state shares the same preparation circuit with an optimal NOON state. The corresponding QFI of an optimal Gaussian state is

$${}^{1} {K}_{Q} = 8 {ε}_{1}^{2} N ( 1 + N ) = 32 \sqrt{{D}_{f}} {λ}_{1}^{2} N ( 1 + N ) . \qquad ( 34 )$$

The QFI with optimal Gaussian state are approximately twice the QFI with NOON state for large N.
Another probe state we consider is,

$${{{\vert {φ}_{2} 〉 = \hat{W} \vert 0 ; r 〉}_{1} \vert a 〉}_{2} … \vert 0 〉}_{{M}_{S}} , \qquad ( 35 )$$

in which Ŵ is an optimal circuit to prepare such a product state. The corresponding QFI is

$${}^{2} {K}_{Q} = 4 {ε}_{1}^{2} ( {a}^{2} {e}^{2 r} + sinh {r}^{2} ) \approx 16 \sqrt{{D}_{f}} {λ}_{1}^{2} N ( N + 1 ) . \qquad ( 36 )$$

The approximation is obtained with optimized power allocation, which is α²≈sinh(r)²≈N/2. ²K_{Q} is approximately the same as an optimal QFI obtained with the NOON state, due to the fact that NOON state and \hat{B}^{†}|0;r [symbol] α [symbol] has high fidelity to one another. However the latter is easier to prepare.

For the three states discussed above, an optimal definite photon number state, an optimal Gaussian state, |φ₁ [symbol] and a specific Gaussian state |φ₂ [symbol] , an optimal preparation circuits always put all the energy to the first MZI, which has the strongest response to a small transverse beam displacement. When we do not consider the diffraction loss, for all the M_{S}/2 MZI's, only the one with strongest response should be employed. For the three input states we presented, when we consider the average mean photon for a single mode, n̅=N/M_{S}, they all achieve Heisenberg scaling, K∝n̅², and super Heisenberg scaling w.r.t M_{S}, K∝M_{S}³, as we have λ₁∝\sqrt{M_{S}}. If we have multiple nodes with the same response to a parameter, employing a single MZI with all the resources or distributing an entangled state equally to all the MZIs will achieve the same precision, as an optimal Gaussian input state already has Heisenberg scaling w.r.t N²=n̅²M_{S}². However, if there is constraints on the mean photon number within a single MZI, the distribution will be helpful.

When loss is present, the quantum enhancement in the large total mean photon number regime is simply a constant factor over SQL scaling. Entanglement among all the sensor nodes will help improve the sensitivity by distributing the recourse to the available nodes. Distributing the probe state to many sensor nodes leads to a scaling of M_{S}²n̅=M_{S}N, which potentially has a factor of M_{S} improvement over scaling simply to N=M_{S}n̅. When the diffraction losses are included, we expect an optimal state to distribute the total energy to the M_{S}/2 MZIs for better performance. We also expect the performance to saturate with the increase of M_{S}. High diffraction loss will render high order HG spatial modes useless.

In this section, we present two types of Gaussian states. The most general M_{S} mode pure Gaussian state in HG modal basis can be transformed into a M_{S} mode product states of displaced squeezed state, in some modal basis, through some passive unitary transformation. Û₀ represents a M_{S} mode passive unitary transformation, which can be decomposed into M_{S} (M_{S}−1)/2 general MZIs and M_{S} single mode phases.

At the transmitter, we will have a multimode pure Gaussian state. After propagation through free space, we will have a mixed state carrying the transverse displacement information. Using the mean and covariance matrix to represent the parameter encoded mixed multi-mode Gaussian state, the fidelity and the quantum fisher information can be obtained. Numerical optimizations over the choice of Û₀ and total mean photon number allocation are done for D_{f}=90. We expect quantum enhancement is most relevant in the low loss regime.

The first type of state of interest is a single mode general Gaussian state |α̅₁;r₁ [symbol] in some spatial mode. In HG modal basis, the state of interest is

$${{{\vert {φ}_{3} 〉 = {\hat{U}}_{0} ( \vec{ξ} , \vec{ψ} , \vec{χ} ) \vert {\vec{a}}_{1} ; {r}_{1} 〉}_{1} \vert 0 〉}_{2} … \vert 0 〉}_{{M}_{S}} , \qquad ( 37 )$$

An optimal Gaussian state, |φ₁ [symbol] , belong to this type of state. This optimization is effectively finding an optimal spatial mode for |α̅₁; r₁ [symbol] , with absolute phase. Using the analytical expression of the mean and covariance matrix for |φ₃ [symbol] , which is in HG modal basis, we can optimize the corresponding QFI with respect to (ξ̅, ψ̅, χ̅) and (α̅₁; r₁) with a total mean photon number constraint, |α̅₁|²+sinh r₁²=N, for M_{S}=2, 4, 6, 8, 10, when D_{f}=90. The corresponding η is 0.9.
Numerical results indicate that QFI of |φ₃ [symbol] is saturated at M_{S}=8. The performance obtained with |φ₁ [symbol] peaks at M_{S}=8 with the increase of M_{S}. It is safe to draw the conclusion that, for D_{f}=90, going over M_{S}=8 bring ignorable performance enhancement for |φ₃ [symbol] type states. Recall that an optimal classical transmitter's performance saturates at M_{S}=22 for D_{f}=90. The quantum transmitter are much more sensitive to loss than coherent state.

The second type of state we study is exciting a two mode Gaussian product state, |α̅₁; r₁)₁|α̅₂; r₂ [symbol] ₂, then distribute it among the M_{S} HG modes through a passive unitary transformation Û₀(ξ̅, ψ̅, χ̅).

$${{{\vert {φ}_{4} 〉 = {\hat{U}}_{0} ( \vec{ξ} , \vec{ψ} , \vec{χ} ) \vert {\vec{a}}_{1} ; {r}_{1} 〉}_{1} \vert {\vec{a}}_{2} ; {r}_{2} 〉}_{2} … \vert 0 〉}_{{M}_{S}} , \qquad ( 38 )$$

|φ₂ [symbol] belong to this type of state and |φ₃ [symbol] is a subgroup of |φ₄ [symbol] .
The universal M_{S} mode passive unitary can be simplified without loss of generality for this type of input state. Only two single mode phases need to be activated. By numerically optimizing the power distribution and (ξ̅, ψ̅, χ̅), there exists significant improvement in QFI between |φ₂ [symbol] and |φ₄ [symbol] ₘₐₓ. In the small N regime, |φ₃ [symbol] ₘₐₓ is an optimal choice, and |φ₄ [symbol] ₘₐₓ will be beneficial when N is big. The black line shows the QFI performance of optimal classical transmitter when D_{f}=90. Our quantum enhanced transmitter could attain a QFI that is approximately 1.5 times the QFI of the classical optimal transmitter.

In order to find an optimal Gaussian state, we need to prepare it by distributing a general M_{S} mode Gaussian product state through a general M_{S} mode passive unitary. For M_{S}=2, |φ₄) is the general Gaussian state. The numerical results indicate that |φ₄ [symbol] is an optimal Gaussian state for M_{S}=2. Especially in large N limit, two modes are both squeezed. For M_{S}=4, numerical optimization with the most general four mode pure Gaussian state, indicates |φ₄ [symbol] is an optimal Gaussian state. Similarly, in large N limit, two modes are both squeezed.

Here we propose that, for single parameter embedded in a multi-mode passive Gaussian unitary with moderate amount of loss, an optimal Gaussian probe states belong to |φ₄ [symbol] .

With the decrease of loss, an optimal state will converge to the type of state represented by |φ₃ [symbol] , and the quantum enhanced probe state will show more improvement over the classical optimal probe state.

From the numerical results, the probe state in the form of |φ₄ [symbol] with Mₛ=8 for D_{f}=90 is a near optimal choice. In this section we present the associated receiver design for this particular probe state. An optimal measurement that attains the QFI, is formed by the eigenbasis of the symmetric logarithmic derivative (SLD) for this eight mode probe state. An optimal measurement for QFI is proven to be equivalent to an optimal measurement for fidelity. The single mode Gaussian state single parameter estimation was proven to have three types of optimal receiver design, not all of which are Gaussian measurements. When the eigenvalues of the G_{M} matrix has opposite sign, an optimal measurement is non-Gaussian.

Following their general expression on the multi-mode Gaussian state's optimal measurement, we found a non-Gaussian receiver design attaining the QFI. But for rank-deficient Gaussian states, an optimal receiver design is not unique. Instead of finding an optimal Gaussian measurement, considering the implementation, we present a two mode Homodyne receiver approaching the QFI in the large N limit. In the large N regime, the two mode Homodyne receiver's CFI approaches the QFI and outperforms an optimal classical transceiver design. In the small N regime, this two mode homodyne is not outperforming an optimal classical transceiver design due to the fact that only up to 8 HG modes are considered for this quantum enhanced transceiver design.

The approach based on the single parameter estimation theory allows one to see the permissible precision limit. It becomes clear how the constraining parameters are affecting the precision. showing a recipe to follow during the design process. The advancement in structured light preparation, both for coherent state and squeezed state, made this multi-modal analysis readily realizable. In the region where significant Heisenberg scaling is prohibited, the classical optimal transmitter is quite powerful.

We now describe an example of the crosstalk matrix for displaced beam. The propagation kernel for a setup with well defined optical axis and soft Gaussian apertures at the transmitter and receiver side is given by

$$h ( ρ , {ρ}_{0} ) = exp ( - \frac{\vert ρ \vert}{{r}_{R}^{2}} ) \frac{exp ( ikL + ik {\vert {ρ}_{0} - ρ \vert}^{2} / 2 L )}{i λ L} exp ( \frac{- {\vert {ρ}_{0} \vert}^{2}}{{r}_{T}^{2}} ) . \qquad ( 39 )$$

in which the ρ₀=(x₀,y₀) represents the coordinate at the transmitter plane, ρ represents the coordinate at the receiver plane, the optical axis is defined as the z-axis. k is the wavenumber, L is the distance between transmitter and receiver plane, X is the wavelength. r_{R} and r_{T} are the soft aperture half width at the receiver side and transmitter side respectively. The first and third element in Equation 39 represent the soft Gaussian apertures at the receiver and transmitter side respectively, and the second element is the Fresnel propagation kernel.

Hermite Gauss modes form a complete orthonormal set of functions for the transmitter and receiver plane. The free space propagation kernel can be write in the form

$$h ( ρ , {ρ}_{0} ) = {\sum }_{n , m = 0}^{∞} \sqrt{{η}^{n + m + 1}} {ϕ}_{n} ( x , {w}_{R} ) {ϕ}_{m} ( y , {w}_{R} ) {Φ}_{n}^{*} ( {x}_{0} , {w}_{T} ) {Φ}_{m}^{*} ( {y}_{0} , {w}_{T} ) , \qquad ( 40 )$$

in which η is the transmissivity for 00-th HG mode. ϕₙ(x, w_{R}) is defined in Equation 2. For a well aligned system, exciting a state in Φₙ(x₀,w_{T})Φ₀(y₀, w_{T}) spatial mode at the transmitter, the field emerging out of the receiver side aperture is in ϕₙ(x, w_{R})ϕ₀(y, w_{R}) spatial mode with a corresponding transmissivity ηⁿ⁺¹.

When the n0-th HG spatial mode, Φₙ(x₀, w_{T})Φ₀(y₀, w_{T}), is excited at the transmitter, propagating through free space and interact with the scene by carrying some information on the transverse beam position, the field emerging from the receiver aperture is

$${u}_{n} ( x + d , y ) exp ( - \frac{{\vert ρ \vert}^{2}}{{r}_{R}^{2}} ) .$$

It is assumed that the field still propagates along z-axis. uₙ(x, y) is the field entering the receiver aperture when the beam does not interact with the scene.

$${u}_{n} ( x , y ) = \sqrt{{η}^{n + 1}} {ϕ}_{n} ( x , {w}_{R} ) {ϕ}_{0} ( y , {w}_{R} ) \times exp ( \frac{{\vert ρ \vert}^{2}}{{r}_{R}^{2}} ) . \qquad ( 41 )$$

The transverse beam displacement induced crosstalk can be obtained by projecting the emerged field onto the receiver HG modes ϕₘ(x)ϕ₀(y). The projection integral, with w_{R} omitted for simplification of representation,

$${\int \int }_{- ∞}^{∞} {ϕ}_{m}^{*} ( x ) {ϕ}_{0}^{*} ( y ) {u}_{n} ( x + d , y ) exp ( - \frac{{\vert ρ \vert}^{2}}{{r}_{R}^{2}} ) dxdy , \\ \begin{matrix}= {\int }_{- ∞}^{∞} {ϕ}_{m}^{*} ( x ) \sqrt{{η}^{n + 1}} {ϕ}_{n} ( x + d ) exp ( \frac{{( x + d )}^{2}}{{r}_{R}^{2}} ) exp ( - \frac{{x}^{2}}{{r}_{R}^{2}} ) dx , \\ = \sqrt{{η}^{n + 1}} exp ( \frac{{d}^{2}}{{r}_{R}^{2}} ) {\int }_{- ∞}^{∞} {ϕ}_{m}^{*} ( x ) {ϕ}_{n} ( x + d ) exp ( \frac{2 xd}{{r}_{R}^{2}} ) dx , \\ = \sqrt{{η}^{n + 1}} exp ( \frac{{d}^{2}}{{r}_{R}^{2}} ) {\int }_{- ∞}^{∞} {ϕ}_{m}^{*} ( x ) [ {ϕ}_{n} ( x ) + d {ϕ}_{n}^{′} ( x ) + O ( {d}^{2} ) ] \\ [ 1 + \frac{2 xd}{{r}_{R}^{2}} + O ( {d}^{2} ) ] dx , \\ = \sqrt{{η}^{n + 1}} ( {δ}_{m , n} + \frac{{dw}_{R}}{{r}_{R}^{2}} ( \sqrt{m + 1} {δ}_{m + 1 , n} + \sqrt{m} {δ}_{m - 1 , n} ) + \\ d ( - \frac{1}{{w}_{R}} + \frac{{ikw}_{R}}{2 L} ) \sqrt{m} {δ}_{m - 1 , n} + d ( \frac{1}{{w}_{R}} + \frac{{ikw}_{R}}{2 L} ) \\ \sqrt{m + 1} {δ}_{m + 1 , n} + O ( {d}^{2} ) ) , \\ \approx \sqrt{{η}^{n + 1}} ( {δ}_{m , n} + \frac{d}{{w}_{R}} ( \sqrt{m + 1} {δ}_{m + 1 , n} - \sqrt{m} {δ}_{m - 1 , n} ) + \\ \frac{{dw}_{R}}{{r}_{R}^{2}} ( \sqrt{m + 1} {δ}_{m + 1 , n} + \sqrt{m} {δ}_{m - 1 , n} ) + \\ \frac{{idkw}_{R}}{2 L} ( \sqrt{m + 1} {δ}_{m + 1 , n} + \sqrt{m} {δ}_{m - 1 , n} ) )\end{matrix} , \qquad ( 42 )$$

To calculate the modal crosstalk, the recurrence relations for Hermite polynomial are used to deduce the recurrence relation of ϕₙ(x, w_{R}).

$${{ϕ}_{n} ( x )}^{′} = \frac{{w}_{R}}{2} ( i \frac{k}{L} - \frac{2}{{w}_{R}^{2}} ) \sqrt{n + 1} {ϕ}_{n + 1} ( x ) + ( i \frac{{kw}_{R}}{2 L} + \frac{1}{{w}_{R}} ) \sqrt{n} {ϕ}_{n - 1} ( x ) , \qquad ( 43 )$$

$${ϕ}_{n + 1} ( x ) = \frac{2 x}{{w}_{R} \sqrt{n + 1}} {ϕ}_{n} ( x ) - \sqrt{\frac{n}{n + 1}} {ϕ}_{n - 1} ( x ) , \qquad ( 44 )$$

The last step of Equation 42 shows that in the limit of small d, the diffraction loss is the same, ηⁿ⁺¹. The transverse induced cross talk matrix is,

$$Q ≡ I + \frac{d}{{w}_{R}} Γ + ( \frac{{dw}_{R}}{{r}_{R}^{2}} + \frac{{idkw}_{R}}{2 L} ) \vert Γ \vert , \qquad ( 45 )$$

in which Γ of the first Mₛ modes is

$$Γ ( {M}_{S} ) = [ \begin{matrix}0 & 1 & 0 & … & 0 \\ - 1 & 0 & \sqrt{2} & … & 0 \\ 0 & - \sqrt{2} & 0 & ⋱ & ⋮ \\ ⋮ & ⋮ & ⋱ & ⋱ & \sqrt{{M}_{S} - 1} \\ 0 & 0 & … & - \sqrt{{M}_{S} - 1} & 0\end{matrix} ] \qquad ( 46 )$$

Each HG mode propagating through free space and experiencing a transverse displacement d, will have diffraction loss and cross to the two neighboring modes. The propagation loss can be modeled as a series of parallel beam splitters on each one of the HG modes.

$$\begin{matrix}Q = I + \frac{d}{{r}_{R}} [ {( 1 + 4 {D}_{f} )}^{1 / 4} Γ + \frac{\vert Γ \vert}{{( 1 + 4 {D}_{f} )}^{1 / 4}} + \frac{{ir}_{R} 2 \sqrt{{D}_{f}}}{{{r}_{T} ( 1 + 4 {D}_{f} )}^{1 / 4}} \vert Γ \vert ] \\ \approx I + \tilde{d} [ {( 1 + 4 {D}_{f} )}^{1 / 4} Γ + \frac{i 2 {r}_{R} \sqrt{{D}_{f}}}{{{r}_{T} ( 1 + 4 {D}_{f} )}^{1 / 4}} \vert Γ \vert ] , \\ \approx I + \tilde{d} [ {( 4 {D}_{f} )}^{1 / 4} Γ + \frac{i 2 \sqrt{{D}_{f}}}{{( 4 {D}_{f} )}^{1 / 4}} \vert Γ \vert ] , \\ \approx I + {( 4 {D}_{f} )}^{1 / 4} \tilde{d} [ Γ + i \vert Γ \vert ]\end{matrix} , \qquad ( 47 )$$

Under the conditions listed above, the crosstalk matrix is a skew Hermitian matrix, [symbol] ≡1+(4D_{f})¼\tilde{d}+|Γ+i|Γ|]. Then for a small transverse displacement, the corresponding unitary is Û(d)=exp{−\overline{\hat{α}}ln( [symbol] )\overline{\hat{α}}}=exp{−id̅Ĥ}, in which the Hamiltonian is in the form,

$$\hat{H} = {( 4 {D}_{f} )}^{1 / 4} {\vec{\hat{a}}}^{†} ( - i Γ + \vert Γ \vert ) \vec{\hat{a}} , \qquad ( 48 )$$

In some implementations, Z(x₀, D_{f})Φ₀(y₀) may be the optimal spatial mode to generate a coherent state in at the transmitter:

$$Z ( {x}_{0} , {D}_{f} ) {Φ}_{0} ( {y}_{0} ) = {\sum }_{n = 0}^{{M}_{S} / 2 - 1} {α}_{2 n + 1} {e}^{in π / 2} {Φ}_{2 n + 1} ( {x}_{0} ) {Φ}_{0} ( {y}_{0} ) , \qquad ( 49 )$$

in which α₂ₙ₊₁ can be found numerically based on the QFI optimization. This spatial mode is normalised, meaning,

$$\int \int Z ( {x}_{0} , {D}_{f} ) {Φ}_{0} ( {y}_{0} ) \times {Z}^{*} ( {x}_{0} , {D}_{f} ) {Φ}_{0}^{*} ( {y}_{0} ) {dx}_{0} {dy}_{0} = 1. \qquad ( 50 )$$

At the receiver, we can account for the modal crosstalk captured by matrix [symbol] . The received field

$${\sum }_{n = 0}^{{M}_{S} / 2 - 1} {α}_{2 n + 1} {η}^{n + 1} {e}^{in π / 2} {ϕ}_{2 n + 1} ( x ) {ϕ}_{0} ( y ) + \tilde{d} {\sum }_{n = 0}^{{M}_{S} / 2} {β}_{2 n} {e}^{i ( {ϑ}_{2 n} + {ϑ}_{0} )} {ϕ}_{2 n} ( x ) {ϕ}_{0} ( y ) , \qquad ( 51 )$$

in which, {ζ₀(x, D_{f})ϕ₀(y), ζ₁(x, D_{f})ϕ₀(y)} is an orthonormal set and:

$${ζ}_{0} ( x , {D}_{f} ) = \frac{1}{\sqrt{{\sum }_{n = 0}^{{M}_{S} / 2 - 1} {α}_{2 n + 1}^{2} {η}^{2 n + 2}}} {\sum }_{n = 0}^{{M}_{S} / 2 - 1} {α}_{2 n + 1} {η}^{n + 1} {e}^{in π / 2} {ϕ}_{2 n + 1} ( x ) {ϕ}_{0} ( y ) \\ {ζ}_{1} ( x , {D}_{f} ) = \frac{1}{\sqrt{{\sum }_{n = 0}^{{M}_{s} / 2} {β}_{2 n}^{2}}} {\sum }_{n = 0}^{{M}_{S} / 2} {β}_{2 n} {e}^{i ( {ϑ}_{2 n} + {ϑ}_{0} )} {ϕ}_{2 n} ( x ) {ϕ}_{0} ( y ) . \qquad ( 52 )$$

The fractions in front of the sums denote the normalization factor. The zeta modes are 1D functions of the x variable, while a dependence on D_{f} in the definition is used to stress that these optimized spatial modes can depend on the system's Fresnel number product.

An example mode sorter may use a bi-orthonormal spatial set of modes. For example, the mode projection receiver could be configured to sort out light in the spatial mode ζ₁(x,y) (e.g., by using biorthonormal basis sets, S₁={ζ₀(x, y), ζ₁(x, y)}×exp(−r²/r_{R}²), and S₂={ζ₀(x,y), ζ₁(x, y)}×exp(r²/r_{R}²)). The received field on the mode projection receiver would then be in the basis of S₂. A phase mask can be produced using the basis S₁, effectively emulating a soft aperture on the projection modes.

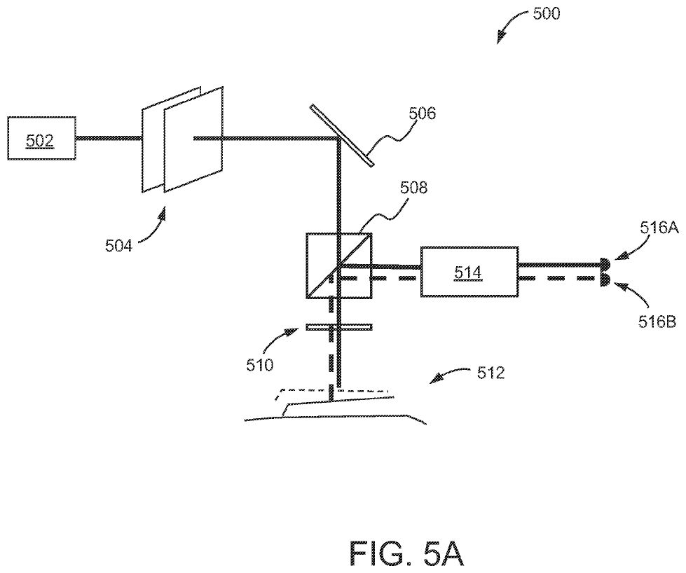

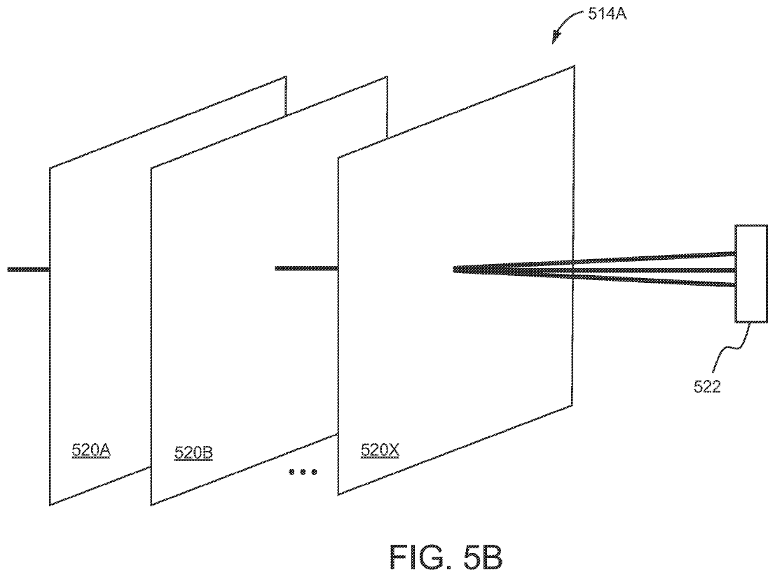

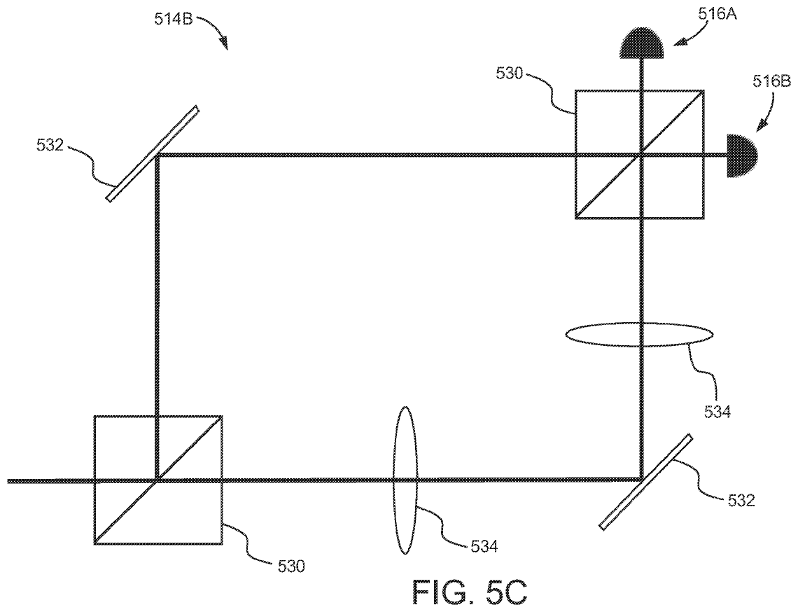

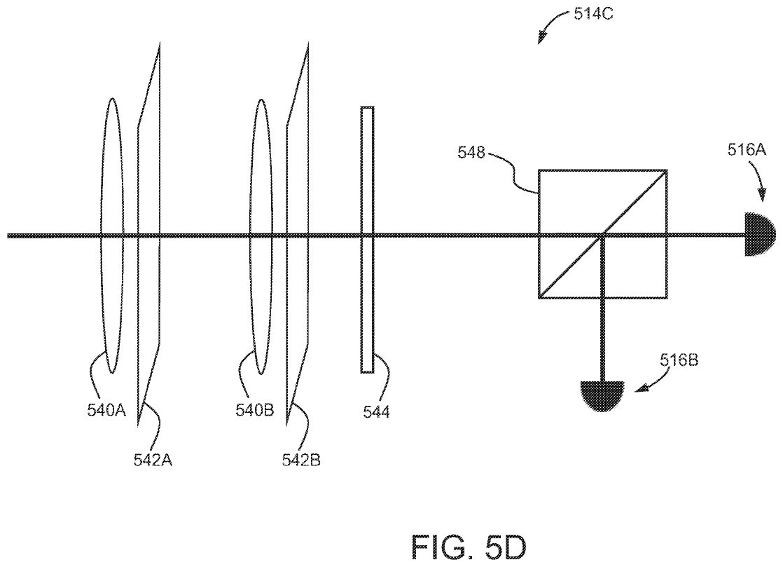

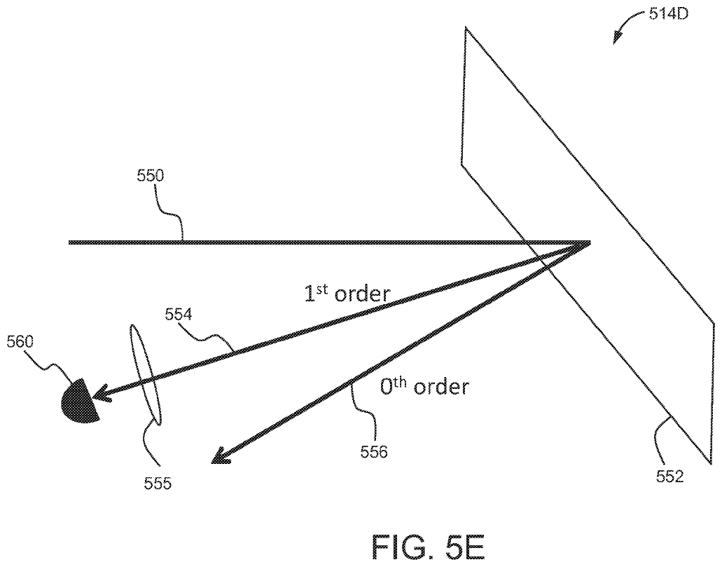

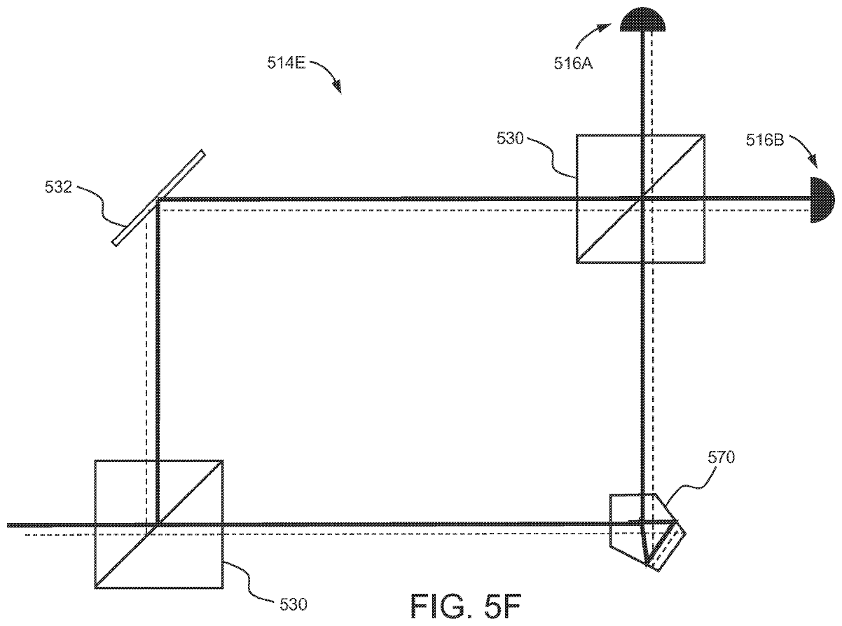

FIG. 5A shows an example of a sensing system 500 that can be configured for performing the techniques described herein. The sensing system 500 includes an optical source 502 (e.g., a laser) that provides a coherent optical wave in the form of a beam that has an initial spatial mode. A set of one or more phase masks 504 is able to structure the beam into a particular spatial mode. Each phase mask is configured as a spatial light modulator (SLM) to modulate light as a function of position over a transverse plane of the beam passing through the phase mask. Depending on the beam structuring technique, for example, using one phase mask with a 4-f system can achieve lossy modulation of both amplitude and phase, and using two phase masks with a 4-f system can achieve lossless modulation of both amplitude and phase. Additionally, the one or more phase masks 504 may act effectively as a soft Gaussian aperture for the beam (e.g., a phase SLM can effectively produce amplitude modulation in the form of a soft aperture). Any number of mirrors or other optical elements, such as mirror 506, can be used as needed to ensure the beam is directed appropriately in a given system configuration. A polarizing beam splitter (PBS) 508 receives a linearly polarized beam and passes at least a portion (or all when appropriately aligned to the PBS) through to a quarter-wave plate (QWP) 510, which will transform the linearly polarized portion into a circularly polarized optical wave. Then, after reflection from measurement module 512 (e.g., an atomic force microscopy system), the return beam passes through the QWP 510 again resulting in a linearly polarized optical wave that has a polarization that is perpendicular to the incoming linearly polarized portion. So, the beam is redirected through a mode sorter 514 that further transforms the beam to be detected at detectors 516A and 516B (e.g., photodiodes or other types of photodetectors that detect the power in the incident optical wave).

In this example, the optical source 502 and the one or more phase masks 504 represent the transmitter portion of the sensing system 500, and the mode sorter 514 and detectors 516A and 516B represent the receiver portion of the sensing system 500, with the combination of the PBS 508, QWP 510, and measurement module 512 representing the path shifting component. FIG. 5B, FIG. 5C, FIG. 5D, FIG. 5E and FIG. 5F show different examples of implementations 514A, 514B, 514C, 514D, and 514E, respectively, of the mode sorter 514.

Referring to FIG. 5B, an example mode sorter 514A is based on a multiplane light conversion (MPLC) arrangement. A set of multiple phase masks 520A, 520B, . . . 520X are configured to perform multiplane light conversion. Additionally, the set of multiple phase masks 520A, 520B, . . . 520X may act effectively as a soft Gaussian aperture for the beam. In this example, there is free space propagation between each of the phase masks and phase modulation over a transverse plane of the beam that is performed at each of the phase masks. The effect of this successive propagation and phase modulation is to separate some spatially collocated spatial modes into spatially separated spots at a two-dimensional (2D) detector 522 (e.g., a CCD camera), which is used in this example in place of the detectors 516A and 516B. The photons in each spatial mode can be detected at different respective portions of the 2D detector 522 (also called spatial mode sorting). Depending on how many spatial modes need to be sorted, and sorting quality, the number of phase masks that are included may vary. Generally, more modes and/or fewer phase masks may degrade the sorting quality. In some implementations, when two spatial modes need to be sorted, three phase masks can be used to provide acceptable sorting quality. In alternative implementations, various alternative arrangements can be used, such as passing the beam through phase masks multiple times, or using reflective instead of transmissive phase masks, or a combination of reflective and transmissive phase masks.

In some implementations of the mode sorter 514A, for a specific set of spatial modes to be sorted, a set of corresponding phase masks can be generated to diverge different spatially collocating modes to different assigned locations on the detector 522. The detector 522 can thus count the photons in each spatial mode. Spatial mode multiplexing and demultiplexing can be a useful tool for harvesting the full potential of light. The number of modes that a mode sorter can sort and the sorting crosstalk matrix may be limited by the number of phase masks available.

Referring to FIG. 5C, an example mode sorter 514B is based on a non-common path Super-Localized Image inVERsion interferometer (SLIVER) arrangement. In this example, there are components forming a Mach-Zehnder interferometer including 50/50 beamsplitters 530, and mirrors 532. One of the arms of the interferometer includes two lenses 534 arranged to form a 4-f relay system, in which the lenses have substantially equal focal lengths (f) and the optical path length between the lenses is substantially equal to twice that focal length (2f). The electromagnetic field of the beam in this arm is spatially inverted in both transverse coordinates compared to the other arm. So, at the two output ports of the interferometer detected by detectors 516A and 516B, the fields represent an odd spatial component of the original field at one detector and an even spatial component of the original field at the other detector. Without intending to be bound by theory, an example of such odd and even spatial components are given by the following equations.

in which

$$\frac{1}{2} ( ϕ ( x , y ) + ϕ ( - x , - y ) ) = {ϕ}_{even} ( x , y ) , \qquad ( 53 )$$

$$\frac{1}{2} ( ϕ ( x , y ) - ϕ ( - x , - y ) ) = {ϕ}_{odd} ( x , y ) , \qquad ( 54 )$$

$$ϕ ( x , y ) = {ϕ}_{odd} ( x , y ) + {ϕ}_{even} ( x , y ) . \qquad ( 55 )$$

In this example, in the small transverse displacement limit, using the techniques described herein for an optimal spatial mode, the transverse displacement is linearly embedded in the amplitude of the spatial mode of the opposite parity. The performance of this SLIVER arrangement can be comparable to the performance of the MPLC arrangement. The two output ports can use a 2D detector (e.g., a CCD camera) to capture the whole field over a 2D spatial distribution over an array of pixels and integrate over the whole 2D spatial distribution. The photons in each spatial mode of interested can be detected in this manner. For some examples (e.g., transverse displacement sensing), the y component is simply Gaussian and

$${ϕ}_{odd} ( x , y ) = - {ϕ}_{odd} ( - x , y ) \qquad ( 56 )$$

$${ϕ}_{even} ( x , y ) = {ϕ}_{even} ( - x , y ) \qquad ( 57 )$$

Other beam inversion techniques may be employed, as shown in FIG. 5F, which only invert the field along one axis (e.g., the x-axis), and are more insensitive to the misalignment along y-direction.

Referring to FIG. 5D, an example mode sorter 514C is based on a common path interferometer arrangement. This example includes a first pair of a lens 540A and a phase mask 542A and a second pair of a lens 540B and a phase mask 542B. The spatial light modulation performed by the phase masks in this example is polarization sensitive phase modulation. In some implementations, instead of a phase mask a metasurface can be used. The pair can be arranged such that the phase mask cancels an effect of the lens. The incoming electromagnetic field can be linearly polarized at 45 degrees with respect to axes of a quarter-wave plate (QWP) 544. So, one of the polarization directions can be inverted. After the QWP 544, the odd spatial component and even spatial component will be encoded in two different directions of polarization. A polarizing beam splitter (PBS) 548 can separate the two different parity portions to be detected by different detectors 516A and 516B. The signals can be processed in a similar manner as the SLIVER arrangement.

In some implementations of the mode sorter 514C, the lens 540A may be a cylindrical lens, while the phase mask 542A may be a cylindrical phase mask, which together form a polarization sensitive cylindrical lens. In some examples, the SLM may only provide phase modulation for s-polarized light. For light along s-polarization, the light will propagate through unmodulated, whereas for p-polarized light, the SLM does not compensate for the phase modulation from the lens. In such an example, the p-polarized light is relayed and partially Fourier transformed twice while the s-polarized light remains collimated:

$$\frac{1}{\sqrt{2}} ϕ ( x , y ) ( \begin{matrix}1 \\ 1\end{matrix} ) \to \frac{1}{\sqrt{2}} ( \begin{matrix}ϕ ( x , y ) \\ i ϕ ( - x , y )\end{matrix} ) \qquad ( 58 )$$

The extra factor of i in the p-polarized light results from the Guoy phase of applying a 1D Fourier transform twice. Using a cylindrical lens allows one to obtain this extra factor of i for later convenience. By writing the received field in circularly polarized basis, we have,

$$\begin{matrix}\frac{1}{\sqrt{2}} ( {\vec{v}}_{s} ϕ ( x , y ) + i {\vec{v}}_{p} ϕ ( - x , y ) ) = \frac{1}{2} [ ( {\vec{v}}_{LHC} + {\vec{v}}_{RHC} ) ϕ ( x , y ) + \\ ( {\vec{v}}_{LHC} - {\vec{v}}_{RHC} ) ϕ ( - x , y ) ] \\ = {ϕ}_{even} ( x , y ) {\vec{v}}_{LHC} + {ϕ}_{odd} ( x , y ) {\vec{v}}_{RHC}\end{matrix} \qquad ( 59 )$$

Then with a 45 degree rotated QWP 544, the circularly polarized light will be rotated back into linearly polarized light. With the polarizing beam splitter 548, the odd component and even component will be separated. Other polarization sensitive elements (e.g., a metasurface that modulates only LHC or RHC light) can be used to modulate only one polarization state for implementation of the common path interferometer arrangement.

Referring to FIG. 5E, an example mode sorter 514D is based on a mode projection receiver design. This example includes a received beam 550 that interacts with a spatial light modulator 552, which produces a zeroth order beam 556 and a first order beam 554. A lens 555 focuses the first order beam 554 onto a detector 560. For tasks such as distinguishing two very closely located point sources, and transverse displacement sensing, one spatial mode may carry a large portion of the information relating to the single parameter of interest. In these situations, using example mode sorter 514D can be advantageous. Despite not being QFI attaining, it may be be simpler to implement. By modulating the phase profile of the incoming beam 550, with a lens 555 performing a Fourier transform, the photons in a specific spatial mode can be projected onto a single pixel.

Referring to FIG. 5F, an example mode sorter 514E is based on a non-common path Super-Localized Image inVERsion interferometer (SLIVER) arrangement. In this example, there are components forming a Mach-Zehnder interferometer including 50/50 beamsplitters 530, a mirror 532, and a pentagonal prism 570. The electromagnetic field of the beam in this arm is spatially inverted in one of the transverse coordinates (e.g., the x-axis) compared to the other arm, thus making the mode sorter 514E more insensitive to misalignment along the non-inverted transverse coordinate (e.g., the y-axis). So, at the two output ports of the interferometer detected by detectors 516A and 516B, the fields represent an odd spatial component of the original field at one detector and an even spatial component of the original field at the other detector.

In some transceiver designs, it can be advantageous to use components that create a soft Gaussian apertures on either the the transmitter or receiver sides, or both. By using such soft Gaussian apertures, the optical modes can remain within the Hermite-Gauss basis. In some examples, spatial light modulators may be used to create the soft Gaussian apertures.

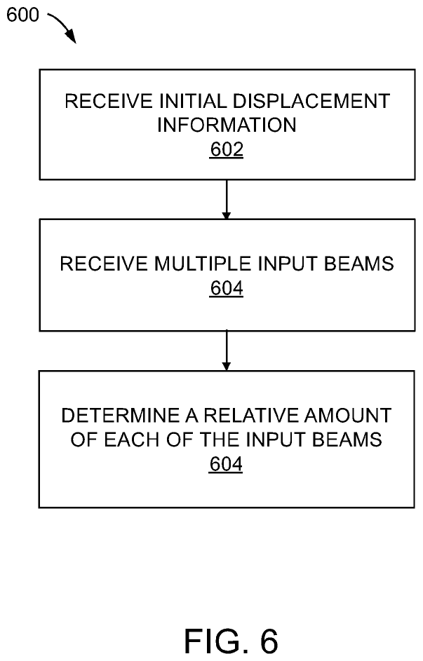

FIG. 6 shows an example of a flowchart for a procedure 600 for providing an optical beam from a transmitter aperture to a receiver aperture that receives the optical beam after displacement of the optical beam within the receiver aperture caused by a path shifting component. The procedure 600 includes receiving (602) initial displacement information characterizing at least one of: an initial estimate of the displacement, or an indication that the displacement is below a predetermined threshold. The procedure 600 includes receiving (604) multiple input beams each having a different spatial mode, from a set of mutually orthogonal spatial modes. The set of mutually orthogonal spatial modes include: a lowest order spatial mode, a highest order spatial mode, and one or more intermediate order spatial modes each having a mode order between the lowest order spatial mode and the highest order spatial mode. The procedure 600 includes determining (606) a relative amount of each of the input beams to be included in the optical beam based at least in part on: corresponding diffraction loss estimates for each of the input beams, and the initial displacement information. In the procedure 600, one of the input beams that has a largest relative amount in the optical beam is one of the intermediate order spatial modes.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for providing an optical beam from a transmitter aperture to a receiver aperture that receives the optical beam after displacement of the optical beam within the receiver aperture caused by a path shifting component, the method comprising:
receiving initial displacement information characterizing at least one of:
an initial estimate of the displacement, or
an indication that the displacement is below a predetermined threshold;
receiving a plurality of input beams each having a different spatial mode, from a set of mutually orthogonal spatial modes, where the set of mutually orthogonal spatial modes include:
a lowest order spatial mode,
a highest order spatial mode, and
one or more intermediate order spatial modes each having a mode order between the lowest order spatial mode and the highest order spatial mode; and
determining a relative amount of each of the input beams to be included in the optical beam based at least in part on:
corresponding diffraction loss estimates for each of the input beams, and
the initial displacement information;
wherein one of the input beams that has a largest relative amount in the optical beam is one of the intermediate order spatial modes.

2. The method of claim 1, wherein each diffraction loss estimate is different and is determined based at least in part on estimates of:
an area of the transmitter aperture,
an area of the receiver aperture,
a propagation distance between the transmitter aperture and the receiver aperture, and
a wavelength of the optical beam.

3. The method of claim 2, wherein a Fresnel number product based on the estimates of the area of the transmitter aperture, the area of the receiver aperture and the propagation distance is greater than 10.

4. The method of claim 1, further including performing an initial measurement to determine the initial estimate of the displacement.

5. The method of claim 1, wherein determining a relative amount of each of the input beams to be included in the optical beam includes performing an optical transformation on one or more of the input beams to produce at least one non-classical squeezed state of at least a portion of the optical beam.

6. The method of claim 5, wherein the non-classical squeezed state is a Gaussian state.

7. The method of claim 1, wherein determining a relative amount of each of the input beams to be included in the optical beam includes performing an optical transformation on one or more of the input beams to produce the optical beam in which all spatial modes of the optical beam are in a classical non-squeezed state.

8. The method of claim 7, wherein the classical non-squeezed state is a Gaussian state.

9. The method of claim 1, further including generating the plurality of input beams from at least one coherent optical beam passed through a spatial mode sorter.

10. The method of claim 1, further including: detecting the optical beam after the optical beam is received by the receiver aperture, and determining a measurement of the displacement based at least in part on one or more detected values.

11. The method of claim 10, wherein the one or more detected values comprise a plurality of detected values from an arrangement of pixels in an image plane.

12. The method of claim 10, wherein the detected values comprise detected photon numbers associated with different spatial modes of the received optical beam.

13. The method of claim 1, wherein the set of mutually orthogonal spatial modes are a finite number of Hermite-Gaussian spatial modes.

14. An apparatus comprising:
a transmitter configured to provide an optical beam from a transmitter aperture, the optical beam comprising a plurality input beams each having a different spatial mode, from a set of mutually orthogonal spatial modes, where the set of mutually orthogonal spatial modes include:
a lowest order spatial mode,
a highest order spatial mode, and
one or more intermediate order spatial modes each having a mode order between the lowest order spatial mode and the highest order spatial mode; and
a receiver configured to receive the optical beam at a receiver aperture after displacement of the optical beam within the receiver aperture caused by a path shifting component, and to provide initial displacement information characterizing at least one of:
an initial estimate of the displacement, or
an indication that the displacement is below a predetermined threshold;
wherein the transmitter is further configured to determine a relative amount of each of the input beams to be included in the optical beam based at least in part on:
corresponding diffraction loss estimates for each of the input beams, and
the initial displacement information;
wherein one of the input beams that has a largest relative amount in the optical beam is one of the intermediate order spatial modes.

15. The apparatus of claim 14, wherein each diffraction loss estimate is different and is determined based at least in part on estimates of:
an area of the transmitter aperture,
an area of the receiver aperture,
a propagation distance between the transmitter aperture and the receiver aperture, and
a wavelength of the optical beam.

16. The apparatus of claim 15, wherein a Fresnel number product based on the estimates of the area of the transmitter aperture, the area of the receiver aperture and the propagation distance is greater than 10.

17. The apparatus of claim 14, wherein the receiver is further configured to perform an initial measurement to determine the initial estimate of the displacement.

18. The apparatus of claim 14, wherein determining a relative amount of each of the input beams to be included in the optical beam includes performing an optical transformation on one or more of the input beams to produce the optical beam in which all spatial modes of the optical beam are in a classical non-squeezed state.

19. The apparatus of claim 18, wherein the classical non-squeezed state is a Gaussian state.

20. The apparatus of claim 14, wherein the transmitter is further configured to generate the plurality of input beams from at least one coherent optical beam passed through a spatial mode sorter.

21. The apparatus of claim 14, wherein the receiver is further configured to detect the optical beam after the optical beam is received by the receiver aperture, and to determine a measurement of the displacement based at least in part on one or more detected values.

22. The apparatus of claim 21, wherein the one or more detected values comprise a plurality of detected values from an arrangement of pixels in an image plane.

23. The apparatus of claim 21, wherein the detected values comprise detected photon numbers associated with different spatial modes of the received optical beam.

24. The apparatus of claim 14, wherein the set of mutually orthogonal spatial modes are a finite number of Hermite-Gaussian spatial modes.
